(19) United States
(12) Patent Application Publication
(10) Pub. No.: US 2020/0200930 A1
(43) Pub. Date: Jun. 25, 2020

(54) Validating Accuracy of Sensor Measurements

(71) Applicant: Schlumberger Technology Corporation, Sugar Land, TX (US)

(72) Inventors: Vishwanathan Parmeshwar, Houston, TX (US); Shunfeng Zheng, Katy, TX (US); Manat Singh, Houston, TX (US)

(21) Appl. No.: 16/227,598

(22) Filed: Dec. 20, 2018

(51) Int. Cl. G01V 1/30; E21B 47/12; E21B 47/01; G01V 1/22; G01V 1/24; G01V 13/00

(52) U.S. Cl. CPC G01V 1/30; E21B 47/124; G01V 13/00; G01V 1/22; G01V 1/24; E21B 47/01

(57) ABSTRACT

Methods and systems for validating accuracy of sensor measurements. A system may include a sensor disposed in association with a piece of equipment at an oil and gas wellsite and a processing device having a processor and a memory storing computer program code. The sensor may be operable to output a first measurement while wellsite operations are being performed. The processing device may be operable to compare the first measurement and a second measurement to each other, and determine accuracy of at least one of the first and second measurements based on the comparison.

### BACKGROUND OF THE DISCLOSURE

Wells are generally drilled into the ground or ocean bed to recover natural deposits of oil, gas, and other materials that are trapped in subterranean formations. Well construction operations (e.g., drilling operations) may be performed at a wellsite by a drilling system having various automated surface and subterranean equipment operating in a coordinated manner. For example, a drive mechanism, such as a top drive or rotary table located at a wellsite surface, can be utilized to rotate and advance a drill string into a subterranean formation to drill a wellbore. The drill string may include a plurality of drill pipes coupled together and terminating with a drill bit. Length of the drill string may be increased by adding additional drill pipes while depth of the wellbore increases. Drilling fluid may be pumped from the wellsite surface down through the drill string to the drill bit. The drilling fluid lubricates and cools the drill bit, and carries drill cuttings from the wellbore back to the wellsite surface. The drilling fluid returning to the surface may then be cleaned and again pumped through the drill string. The equipment of the drilling system may be grouped into various subsystems, wherein each subsystem performs a different operation controlled by a corresponding local and/or a remotely located controller.

The wellsite equipment is typically monitored and controlled from a control center located at the wellsite surface. A typical control center houses a control station operable to receive sensor signals from the wellsite equipment, permit monitoring of the wellsite equipment by the wellsite control station and/or by human wellsite operators. The wellsite equipment may then be automatically controlled by the wellsite control station or manually by the wellsite operator based on sensor measurements received by the wellsite control station. Because the various pieces of wellsite equipment often operate in a coordinated manner, accuracy of measurements performed by various sensors is vital to achieve safe and efficient operation of such equipment. An inaccurate sensor may cause improper operation (e.g., failure in mechanization, failure in synchronization) not just of the piece of equipment comprising the sensor, but other equipment as well. Inaccurate sensor measurements can also cause improper decision making by the control station and/or wellsite operators. Furthermore, inaccurate sensor measurements can lead to loss of productivity, higher consumption of resources, and higher maintenance costs.

One way of ensuring accuracy of sensor measurements is to calibrate sensors on a regular basis. However, a typical calibration process involves removing the sensor from the associated piece of wellsite equipment and connecting the sensor to a testing device to be checked against a reference. Because knowledge that a sensor is out of calibration is acquired after calibration, calibration does not validate accuracy of sensor measurements while the sensor is installed in association with the equipment.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a method including commencing operation of a processing device, whereby the processing device receives a sensor measurement output from a sensor at an oil and gas wellsite while a wellsite operation is being performed, compares the sensor measurement to a known quantity, and determines accuracy of the sensor measurement based on the comparison.

The present disclosure also introduces a method including commencing operation of a processing device, whereby the processing device compares a first measurement to a second measurement. The first measurement is output by a first sensor at an oil and gas wellsite while a wellsite operation is performed, and the second measurement is output by a second sensor at the wellsite while the wellsite operation is performed. Operation of the processing device also entails determining accuracy of at least one of the first and second measurements based on the comparison of the first and second measurements.

The present disclosure also introduces a system including a sensor disposed in association with a piece of equipment at an oil and gas wellsite. The sensor outputs a first measurement while a wellsite operation is performed. The system also includes a processing device having a processor and a memory storing computer program code. The processing device compares the first measurement to a second measurement and determines accuracy of at least one of the first and second measurements based on the comparison.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIGS. 3-6 are graphs related to one or more aspects of the present disclosure.

FIG. 7 is a schematic view of at least a portion of an example implementation of apparatus according to one or more aspects of the present disclosure.

FIG. 8 is a graph related to one or more aspects of the present disclosure.

FIG. 9 is a schematic view of at least a portion of an example implementation of apparatus according to one or more aspects of the present disclosure.

FIGS. 10 and 11 are graphs related to one or more aspects of the present disclosure.

FIG. 12 is a schematic view of at least a portion of an example implementation of apparatus according to one or more aspects of the present disclosure.

FIGS. 13-19 are graphs related to one or more aspects of the present disclosure.

FIG. 20 is a schematic view of at least a portion of an example implementation of apparatus according to one or more aspects of the present disclosure.

FIGS. 21-27 are graphs related to one or more aspects of the present disclosure.

FIG. 28 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

Systems and methods (e.g., processes, operations) according to one or more aspects of the present disclosure may be utilized or otherwise implemented in association with an automated well construction system at an oil and gas wellsite, such as for constructing a wellbore to obtain hydrocarbons (e.g., oil and/or gas) from a subterranean formation. However, one or more aspects of the present disclosure may be utilized or otherwise implemented in association with other automated systems in the oil and gas industry and other industries. For example, one or more aspects of the present disclosure may be implemented in association with wellsite systems for performing fracturing, cementing, acidizing, chemical injecting, and/or water jet cutting operations, among other examples. One or more aspects of the present disclosure may also be implemented in association with mining sites, building construction sites, and/or other work sites where automated machines or equipment are utilized.

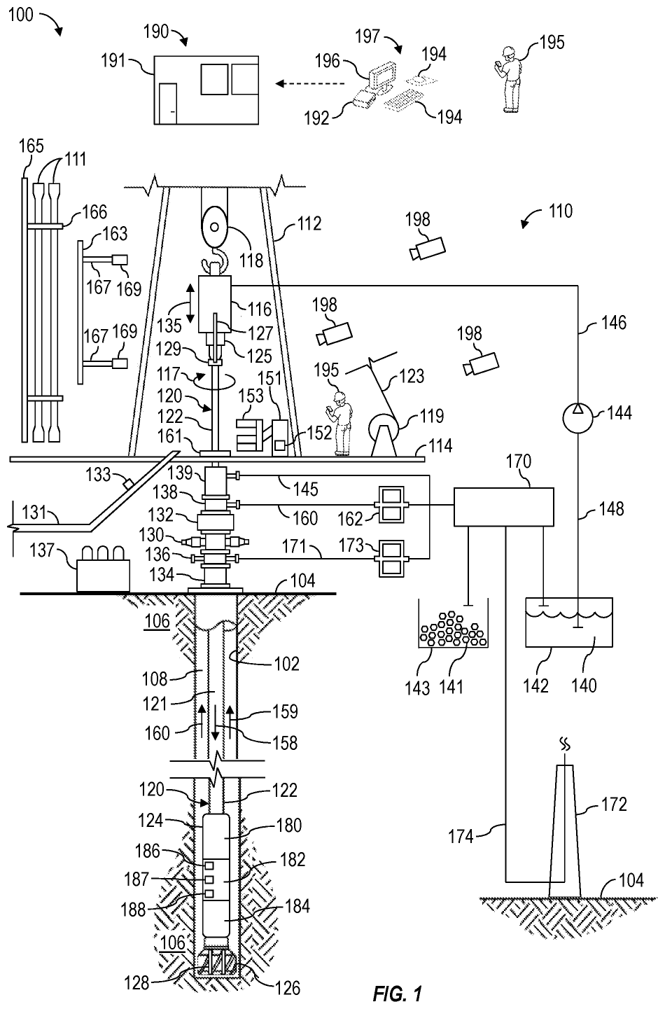

FIG. 1 is a schematic view of at least a portion of an example implementation of a well construction system 100 according to one or more aspects of the present disclosure. The well construction system 100 represents an example environment in which one or more aspects of the present disclosure described below may be implemented. Although the well construction system 100 is depicted as an onshore implementation, the aspects described below are also applicable to offshore implementations.

The well construction system 100 is depicted in relation to a wellbore 102 formed by rotary and/or directional drilling from a wellsite surface 104 and extending into a subterranean formation 106. The well construction system 100 includes surface equipment 110 located at the wellsite surface 104 and a drill string 120 suspended within the wellbore 102. The surface equipment 110 may include a mast, a derrick, and/or another support structure 112 disposed over a rig floor 114. The drill string 120 may be suspended within the wellbore 102 from the support structure 112. The support structure 112 and the rig floor 114 are collectively supported over the wellbore 102 by legs and/or other support structures (not shown).

The drill string 120 may comprise a bottom-hole assembly (BHA) 124 and means 122 for conveying the BHA 124 within the wellbore 102. The conveyance means 122 may comprise drill pipe, heavy-weight drill pipe (HWDP), wired drill pipe (WDP), tough logging condition (TLC) pipe, coiled tubing, and/or other means for conveying the BHA 124 within the wellbore 102. A downhole end of the BHA 124 may include or be coupled to a drill bit 126. Rotation of the drill bit 126 and the weight of the drill string 120 collectively operate to form the wellbore 102. The drill bit 126 may be rotated from the wellsite surface 104 and/or via a downhole mud motor (not shown) connected with the drill bit 126.

The BHA 124 may also include various downhole tools 180, 182, 184. One or more of such downhole tools 180, 182, 184 may be or comprise an acoustic tool, a density tool, a directional drilling tool, an electromagnetic (EM) tool, a formation sampling tool, a formation testing tool, a gravity tool, a monitoring tool, a neutron tool, a nuclear tool, a photoelectric factor tool, a porosity tool, a reservoir characterization tool, a resistivity tool, a rotational speed sensing tool, a sampling-while-drilling (SWD) tool, a seismic tool, a surveying tool, a torsion sensing tool, and/or other measuring-while-drilling (MWD) or logging-while-drilling (LWD) tools.

One or more of the downhole tools 180, 182, 184 may be or comprise an MWD or LWD tool comprising a sensor package 186 operable for the acquisition of measurement data pertaining to the BHA 124, the wellbore 102, and/or the formation 106. One or more of the downhole tools 180, 182, 184 and/or another portion of the BHA 124 may also comprise a telemetry device 187 operable for communication with the surface equipment 110, such as via mud-pulse telemetry. One or more of the downhole tools 180, 182, 184 and/or another portion of the BHA 124 may also comprise a downhole processing device 188 operable to receive, process, and/or store information received from the surface equipment 110, the sensor package 186, and/or other portions of the BHA 124. The processing device 188 may also store executable computer programs (e.g., program code instructions), including for implementing one or more aspects of the operations described herein.

The support structure 112 may support a driver, such as a top drive 116, operable to connect (perhaps indirectly) with an uphole end of the conveyance means 122, and to impart rotary motion 117 and vertical motion 135 to the drill string 120 and the drill bit 126. However, another driver, such as a kelly and rotary table (neither shown), may be utilized instead of or in addition to the top drive 116 to impart the rotary motion 117. The top drive 116 and the connected drill string 120 may be suspended from the support structure 112 via hoisting equipment, which may include a traveling block 118, a crown block (not shown), and a draw works 119 storing a support cable or line 123. The crown block may be connected to or otherwise supported by the support structure 112, and the traveling block 118 may be coupled with the top drive 116, such as via a hook. The draw works 119 may be mounted on or otherwise supported by the rig floor 114. The crown block and traveling block 118 comprise pulleys or sheaves around which the support line 123 is reeved to operatively connect the crown block, the traveling block 118, and the draw works 119 (and perhaps an anchor). The draw works 119 may thus selectively impart tension to the support line 123 to lift and lower the top drive 116, resulting in the vertical motion 135. The draw works 119 may comprise a drum, a frame, and a prime mover (e.g., an engine or motor) (not shown) operable to drive the drum to rotate and reel in the support line 123, causing the traveling block 118 and the top drive 116 to move upward. The draw works 119 may be operable to release the support line 123 via a controlled rotation of the drum, causing the traveling block 118 and the top drive 116 to move downward.

The top drive 116 may comprise a grabber, a swivel (neither shown), a tubular handling assembly links 127 terminating with an elevator 129, and a drive shaft 125 operatively connected with a prime mover (not shown), such as via a gear box or transmission (not shown). The drill string 120 may be mechanically coupled to the drive shaft 125 with or without a sub saver between the drill string 120 and the drive shaft 125. The prime mover may be selectively operated to rotate the drive shaft 125 and the drill string 120 coupled with the drive shaft 125. Hence, during drilling operations, the top drive 116 in conjunction with operation of the draw works 119 may advance the drill string 120 into the formation 106 to form the wellbore 102. The tubular handling assembly links 127 and the elevator 129 of the top drive 116 may handle tubulars (e.g., drill pipes, drill collars, casing joints, etc.) that are not mechanically coupled to the drive shaft 125. For example, when the drill string 120 is being tripped into or out of the wellbore 102, the elevator 129 may grasp the tubulars of the drill string 120 such that the tubulars may be raised and/or lowered via the hoisting equipment mechanically coupled to the top drive 116. The grabber may include a clamp that clamps onto a tubular when making up and/or breaking out a connection of a tubular with the drive shaft 125. The top drive 116 may have a guide system (not shown), such as rollers that track up and down a guide rail on the support structure 112. The guide system may aid in keeping the top drive 116 aligned with the wellbore 102, and in preventing the top drive 116 from rotating during drilling by transferring reactive torque to the support structure 112.

The well construction system 100 may further include a well control system for maintaining well pressure control. For example, the drill string 120 may be conveyed within the wellbore 102 through various blowout preventer (BOP) equipment disposed at the wellsite surface 104 on top of the wellbore 102 and perhaps below the rig floor 114. The BOP equipment may be operable to control pressure within the wellbore 102 via a series of pressure barriers (e.g., rams) between the wellbore 102 and the wellsite surface 104. The BOP equipment may include a BOP stack 130, an annular preventer 132, and/or a rotating control device (RCD) 138 mounted above the annular preventer 132. The BOP equipment 130, 132, 138 may be mounted on top of a wellhead 134. The well control system may further include a BOP control unit 137 (i.e., a BOP closing unit) operatively connected with the BOP equipment 130, 132, 138 and operable to actuate, drive, operate or otherwise control the BOP equipment 130, 132, 138. The BOP control unit 137 may be or comprise a hydraulic fluid power unit fluidly connected with the BOP equipment 130, 132, 138 and selectively operable to hydraulically drive various portions (e.g., rams, valves, seals) of the BOP equipment 130, 132, 138.

The well construction system 100 may further include a drilling fluid circulation system operable to circulate fluids between the surface equipment 110 and the drill bit 126 during drilling and other operations. For example, the drilling fluid circulation system may be operable to inject a drilling fluid from the wellsite surface 104 into the wellbore 102 via an internal fluid passage 121 extending longitudinally through the drill string 120. The drilling fluid circulation system may comprise a pit, a tank, and/or other fluid container 142 holding the drilling fluid (i.e., mud) 140, and a pump 144 operable to move the drilling fluid 140 from the container 142 into the fluid passage 121 of the drill string 120 via a fluid conduit 146 extending from the pump 144 to the top drive 116 and an internal passage extending through the top drive 116. The fluid conduit 146 may comprise one or more of a pump discharge line, a stand pipe, a rotary hose, and a gooseneck (not shown) connected with a fluid inlet of the top drive 116. The pump 144 and the container 142 may be fluidly connected by a fluid conduit 148, such as a suction line.

During drilling operations, the drilling fluid may continue to flow downhole through the internal passage 121 of the drill string 120, as indicated by directional arrow 158. The drilling fluid may exit the BHA 124 via ports 128 in the drill bit 126 and then circulate uphole through an annular space 108 (“annulus”) of the wellbore 102 defined between an exterior of the drill string 120 and the wall of the wellbore 102, such flow being indicated by directional arrows 159. In this manner, the drilling fluid lubricates the drill bit 126 and carries formation cuttings uphole to the wellsite surface 104. The returning drilling fluid may exit the annulus 108 via a bell nipple 139, an RCD 138, and/or a ported adapter 136 (e.g., a spool, a wing valve, etc.) located below one or more portions of the BOP stack 130.

The drilling fluid exiting the annulus 108 via the bell nipple 139 may be directed toward drilling fluid reconditioning equipment 170 via a fluid conduit 145 (e.g., gravity return line) to be cleaned and/or reconditioned, as described below, prior to being returned to the container 142 for recirculation. The drilling fluid exiting the annulus 108 via the RCD 138 may be directed into a fluid conduit 160 (e.g., a drilling pressure control line), and may pass through various wellsite equipment fluidly connected along the conduit 160 prior to being returned to the container 142 for recirculation. For example, the drilling fluid may pass through a choke manifold 162 (e.g., a drilling pressure control choke manifold) and then through the drilling fluid reconditioning equipment 170. The choke manifold 162 may include at least one choke and a plurality of fluid valves (neither shown) collectively operable to control the flow through and out of the choke manifold 162. Backpressure may be applied to the annulus 108 by variably restricting flow of the drilling fluid or other fluids flowing through the choke manifold 162. The greater the restriction to flow through the choke manifold 162, the greater the backpressure applied to the annulus 108. The drilling fluid exiting the annulus 108 via the ported adapter 136 may be directed into a fluid conduit 171 (e.g., rig choke line), and may pass through various equipment fluidly connected along the conduit 171 prior to being returned to the container 142 for recirculation. For example, the drilling fluid may pass through a choke manifold 173 (e.g., a rig choke manifold, well control choke manifold) and then through the drilling fluid reconditioning equipment 170. The choke manifold 173 may include at least one choke and a plurality of fluid valves (neither shown) collectively operable to control the flow through the choke manifold 173. Backpressure may be applied to the annulus 108 by variably restricting flow of the drilling fluid or other fluids flowing through the choke manifold 173.

Before being returned to the container 142, the drilling fluid returning to the wellsite surface 104 may be cleaned and/or reconditioned via drilling fluid reconditioning equipment 170, which may include one or more of liquid gas separators, shale shakers, centrifuges, and other drilling fluid cleaning equipment. The liquid gas separators may remove formation gasses entrained in the drilling fluid discharged from the wellbore 102 and the shale shakers may separate and remove solid particles 141 (e.g., drill cuttings) from the drilling fluid. The drilling fluid reconditioning equipment 170 may further comprise equipment operable to remove additional gas and finer formation cuttings from the drilling fluid and/or modify physical properties or characteristics (e.g., rheology) of the drilling fluid. For example, the drilling fluid reconditioning equipment 170 may include a degasser, a desander, a desilter, a mud cleaner, and/or a decanter, among other examples. Intermediate tanks/containers (not shown) may be utilized to hold the drilling fluid while the drilling fluid progresses through the various stages or portions of the drilling fluid reconditioning equipment 170. The cleaned/reconditioned drilling fluid may be transferred to the fluid container 142, the solid particles 141 removed from the drilling fluid may be transferred to a solids container 143 (e.g., a reserve pit), and/or the removed gas may be transferred to a flare stack 172 via a conduit 174 (e.g., a flare line) to be burned or to a container (not shown) for storage and removal from the wellsite.

The surface equipment 110 may include tubular handling equipment operable to store, move, connect, and disconnect tubulars (e.g., drill pipes) to assemble and disassemble the conveyance means 122 of the drill string 120 during drilling operations. For example, a catwalk 131 may be utilized to convey tubulars from a ground level, such as along the wellsite surface 104, to the rig floor 114, permitting the tubular handling assembly links 127 to grab and lift the tubulars above the wellbore 102 for connection with previously deployed tubulars. The catwalk 131 may have a horizontal portion and an inclined portion that extends between the horizontal portion and the rig floor 114. The catwalk 131 may comprise a skate 133 movable along a groove (not shown) extending longitudinally along the horizontal and inclined portions of the catwalk 131. The skate 133 may be operable to convey (e.g., push) the tubulars along the catwalk 131 to the rig floor 114. The skate 133 may be driven along the groove by a drive system (not shown), such as a pulley system or a hydraulic system. Additionally, one or more racks (not shown) may adjoin the horizontal portion of the catwalk 131. The racks may have a spinner unit for transferring tubulars to the groove of the catwalk 131.

An iron roughneck 151 may be positioned on the rig floor 114. The iron roughneck 151 may comprise a torquing portion 153, such as may include a spinner and a torque wrench comprising a lower tong and an upper tong. The torquing portion 153 of the iron roughneck 151 may be moveable toward and at least partially around the drill string 120, such as may permit the iron roughneck 151 to make up and break out connections of the drill string 120. The torquing portion 153 may also be moveable away from the drill string 120, such as may permit the iron roughneck 151 to move clear of the drill string 120 during drilling operations. The spinner of the iron roughneck 151 may be utilized to apply low torque to make up and break out threaded connections between tubulars of the drill string 120, and the torque wrench may be utilized to apply a higher torque to tighten and loosen the threaded connections. The iron roughneck 151 may carry or comprise one or more sensors 152 operable to generate sensor measurements indicative of torque applied by one or more portions of the iron roughneck 151.

Reciprocating slips 161 may be located on the rig floor 114, such as may accommodate therethrough the downhole tubulars during make up and break out operations and during the drilling operations. The reciprocating slips 161 may be in an open position during drilling operations to permit advancement of the drill string 120 therethrough, and in a closed position to clamp an upper end of the conveyance means 122 (e.g., assembled tubulars) to thereby suspend and prevent advancement of the drill string 120 within the wellbore 102, such as during the make up and break out operations.

During drilling operations, the hoisting equipment lowers the drill string 120 while the top drive 116 rotates the drill string 120 to advance the drill string 120 downward within the wellbore 102 and into the formation 106. During the advancement of the drill string 120, the reciprocating slips 161 are in an open position, and the iron roughneck 151 is moved away or is otherwise clear of the drill string 120. When the upper portion of the tubular in the drill string 120 that is made up to the drive shaft 125 is near the reciprocating slips 161 and/or the rig floor 114, the top drive 116 ceases rotating and the reciprocating slips 161 close to clamp the tubular made up to the drive shaft 125. The grabber of the top drive 116 then clamps the upper portion of the tubular made up to the drive shaft 125, and the drive shaft 125 rotates in a direction reverse from the drilling rotation to break out the connection between the drive shaft 125 and the made up tubular. The grabber of the top drive 116 may then release the tubular of the drill string 120.

Multiple tubulars may be loaded on the rack of the catwalk 131 and individual tubulars (or stands of two or three tubulars) may be transferred from the rack to the groove in the catwalk 131, such as by the spinner unit. The tubular positioned in the groove may be conveyed along the groove by the skate 133 until an end of the tubular projects above the rig floor 114. The elevator 129 of the top drive 116 then grasps the protruding end, and the draw works 119 is operated to lift the top drive 116, the elevator 129, and the new tubular.

The hoisting equipment then raises the top drive 116, the elevator 129, and the tubular until the tubular is aligned with the upper portion of the drill string 120 clamped by the slips 161. The iron roughneck 151 is moved toward the drill string 120, and the lower tong of the torquing portion 153 clamps onto the upper portion of the drill string 120. The spinning system rotates the new tubular (e.g., a threaded male end) into the upper portion of the drill string 120 (e.g., a threaded female end). The upper tong then clamps onto the new tubular and rotates with high torque to complete making up the connection with the drill string 120. In this manner, the new tubular becomes part of the drill string 120. The iron roughneck 151 then releases and moves clear of the drill string 120.

The grabber of the top drive 116 may then clamp onto the drill string 120. The drive shaft 125 (e.g., a threaded male end) is brought into contact with the drill string 120 (e.g., a threaded female end) and rotated to make up a connection between the drill string 120 and the drive shaft 125. The grabber then releases the drill string 120, and the reciprocating slips 161 are moved to the open position. The drilling operations may then resume.

The tubular handling equipment may further include a pipe handling manipulator (PHM) 163 disposed in association with a pipe rack assembly or setback 165. Although the PHM 163 and the setback 165 are shown separate and distinct from the support structure 112, each of the PHM 163 and the setback 165 may be supported by or otherwise connected with the support structure 112 or another portion of the well construction system 100. The setback 165 provides storage (e.g., temporary storage) of tubulars (or stands of two or three tubulars) 111 during various operations, such as during and between tripping out and tripping in the drill string 120. The setback 165 may comprise a fingerboard 166 defining a plurality of slots configured to support or otherwise hold the tubulars 111. The PHM 163 may be operable to transfer the tubulars 111 between the setback 165 and the drill string 120 (i.e., space above the suspended drill string 120). For example, the PHM 163 may include arms 167 terminating with clamps 169, such as may be operable to grasp and/or clamp onto one of the tubulars 111. The arms 167 of the PHM 163 may extend and retract, and/or at least a portion of the PHM 163 may be rotatable and/or movable toward and away from the drill string 120, such as may permit the PHM 163 to transfer the tubular 111 between the setback 165 and the drill string 120.

To trip out the drill string 120, the top drive 116 is raised, the reciprocating slips 161 are closed around the drill string 120, and the elevator 129 is closed around the drill string 120. The grabber of the top drive 116 clamps the upper portion of the tubular made up to the drive shaft 125. The drive shaft 125 then rotates in a direction reverse from the drilling rotation to break out the connection between the drive shaft 125 and the drill string 120. The grabber of the top drive 116 then releases the tubular of the drill string 120, and the drill string 120 is suspended by (at least in part) the elevator 129. The iron roughneck 151 is moved toward the drill string 120. The lower tong clamps onto a lower tubular below a connection of the drill string 120, and the upper tong clamps onto an upper tubular above that connection. The upper tong then rotates the upper tubular to provide a high torque to break out the connection between the upper and lower tubulars. The spinning system then rotates the upper tubular to separate the upper and lower tubulars, such that the upper tubular is suspended above the rig floor 114 by the elevator 129. The iron roughneck 151 then releases the drill string 120 and moves clear of the drill string 120.

The PHM 163 may then move toward the drill string 120 to grasp the tubular suspended from the elevator 129. The elevator 129 then opens to release the tubular. The PHM 163 then moves away from the drill string 120 while grasping the tubular with the clamps 169, places the tubular in the setback 165, and releases the tubular for storage in the setback 165. This process is repeated until the intended length of drill string 120 is removed from the wellbore 102.

The surface equipment 110 of the well construction system 100 may also comprise a control center 190 from which various portions of the well construction system 100, such as the top drive 116, the hoisting system, the tubular handling system, the drilling fluid circulation system, the well control system, the BHA 124, among other examples, may be monitored and controlled. The control center 190 may be located on the rig floor 114 or another location of the well construction system 100, such as the wellsite surface 104. The control center 190 may comprise a facility 191 (e.g., a room, a cabin, a trailer, etc.) containing a control workstation 197, which may be operated by a human wellsite operator 195 to monitor and control various wellsite equipment or portions of the well construction system 100. The control workstation 197 may comprise or be communicatively connected with a processing device 192 (e.g., a controller, a computer, etc.), such as may be operable to receive, process, and output information to monitor operations of and provide control to one or more portions of the well construction system 100. For example, the processing device 192 may be communicatively connected with the various surface and downhole equipment described herein, and may be operable to receive signals from and transmit signals to such equipment to perform various operations described herein. The processing device 192 may store executable program code, instructions, and/or operational parameters or set-points, including for implementing one or more aspects of methods and operations described herein. The processing device 192 may be located within and/or outside of the facility 191.

The control workstation 197 may be operable for entering or otherwise communicating control commands to the processing device 192 by the wellsite operator 195, and for displaying or otherwise communicating information from the processing device 192 to the wellsite operator 195. The control workstation 197 may comprise a plurality of human-machine interface (HMI) devices, including one or more input devices 194 (e.g., a keyboard, a mouse, a joystick, a touchscreen, etc.) and one or more output devices 196 (e.g., a video monitor, a touchscreen, a printer, audio speakers, etc.). Communication between the processing device 192, the input and output devices 194, 196, and the various wellsite equipment may be via wired and/or wireless communication means. However, for clarity and ease of understanding, such communication means are not depicted, and a person having ordinary skill in the art will appreciate that such communication means are within the scope of the present disclosure.

Well construction systems within the scope of the present disclosure may include more or fewer components than as described above and depicted in FIG. 1. Additionally, various equipment and/or subsystems of the well construction system 100 shown in FIG. 1 may include more or fewer components than as described above and depicted in FIG. 1. For example, various engines, motors, hydraulics, actuators, valves, and/or other components not explicitly described herein may be included in the well construction system 100, and are within the scope of the present disclosure.

The well construction system 100 also includes stationary and/or mobile video cameras 198 disposed or utilized at various locations within the well construction system 100. The video cameras 198 capture videos of various portions, equipment, or subsystems of the well construction system 100, and perhaps the wellsite operators 195 and the actions they perform, during or otherwise in association with the wellsite operations, including while performing repairs to the well construction system 100 during a breakdown. For example, the video cameras 198 may capture digital images (or video frames) of the entire well construction system 100 and/or specific portions of the well construction system 100, such as the top drive 116, the iron roughneck 151, the PHM 163, the setback 165, and/or the catwalk 131, among other examples. The video cameras 198 generate corresponding video signals (i.e., feeds) comprising or otherwise indicative of the captured digital images. The video cameras 198 may be in signal communication with the processing device 192, such as may permit the video signals to be processed and transmitted to the control workstation 197 and, thus, permit the wellsite operators 195 to view various portions or components of the well construction system 100 on one or more of the output devices 196. The processing device 192 or another portion of the control workstation 197 may be operable to record the video signals generated by the video cameras 198.

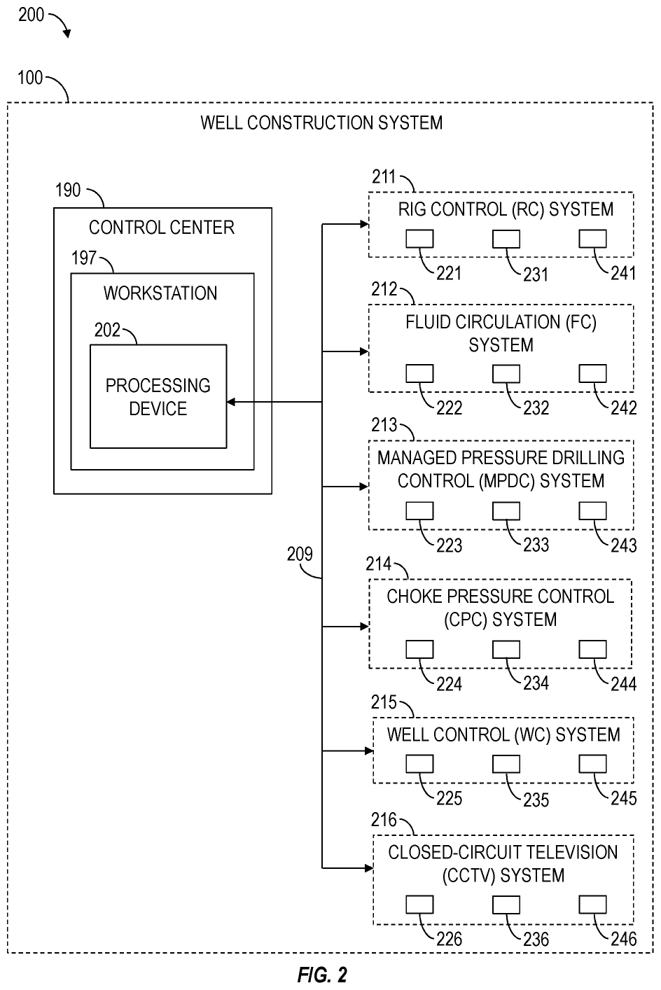

The present disclosure further provides various implementations of systems and/or methods for controlling one or more portions of the well construction system 100. FIG. 2 is a schematic view of at least a portion of an example implementation of a monitoring and control system 200 for monitoring and controlling various equipment, portions, and subsystems of the well construction system 100 according to one or more aspects of the present disclosure. The following description refers to FIGS. 1 and 2, collectively.

The control system 200 may be in real-time communication with and utilized to monitor and/or control various portions, components, and equipment of the well construction system 100 described herein. The equipment of the well construction system 100 may be grouped into several subsystems, each operable to perform a corresponding operation and/or a portion of the well construction operations described herein. The subsystems may include a rig control (RC) system 211, a fluid circulation (FC) system 212, a managed pressure drilling control (MPDC) system 213, a choke pressure control (CPC) system 214, a well pressure control (WC) system 215, and a closed-circuit television (CCTV) system 216. The control workstation 197 may be utilized to monitor, configure, control, and/or otherwise operate one or more of the well construction subsystems 211-216.

The RC system 211 may include the support structure 112, the drill string hoisting system or equipment (e.g., the draw works 119), drill string rotational system (e.g., the top drive 116 and/or the rotary table and kelly), the reciprocating slips 161, the drill pipe handling system or equipment (e.g., the catwalk 131, the PHM 163, the setback 165, and the iron roughneck 151), electrical generators, and other equipment. Accordingly, the RC system 211 may perform power generation controls and drill pipe handling, hoisting, and rotation operations. The RC system 211 may also serve as a support platform for drilling equipment and staging ground for rig operations, such as connection make up and break out operations described above. The FC system 212 may include the drilling fluid 140, the pumps 144, drilling fluid loading equipment, the drilling fluid reconditioning equipment 170, the flare stack 172, and/or other fluid control equipment. Accordingly, the FC system 212 may perform fluid operations of the well construction system 100. The MPDC system 213 may include the RCD 138, the choke manifold 162, downhole pressure sensors 186, and/or other equipment. The CPC system 214 may comprise the choke manifold 173, and/or other equipment, and the WC system 215 may comprise the BOP equipment 130, 132, 138, the BOP control unit 137, and a BOP control station (not shown) for controlling the BOP control unit 137. The CCTV system 216 may include the video cameras 198 and corresponding actuators (e.g., motors) for moving or otherwise controlling direction of the video cameras 198. The CCTV system 216 may be utilized to capture real-time video of various portions or subsystems 211-215 of the well construction system 100 and display video signals from the video cameras 198 on the video output devices 196 to display in real-time the various portions or subsystems 211-215. Each of the well construction subsystems 211-216 may further comprise various communication equipment (e.g., modems, network interface cards, etc.) and communication conductors (e.g., cables), communicatively connecting the equipment (e.g., sensors and actuators) of each subsystem 211-216 with the control workstation 197 and/or other equipment. Although the wellsite equipment listed above and shown in FIG. 1 is associated with certain wellsite subsystems 211-216, such associations are merely examples that are not intended to limit or prevent such wellsite equipment from being associated with two or more wellsite subsystems 211-216 and/or different wellsite subsystems 211-216.

The control system 200 may also include various local controllers 221-226 associated with corresponding subsystems 211-216 and/or individual pieces of equipment of the well construction system 100. As described above, each well construction subsystem 211-216 includes various wellsite equipment comprising corresponding actuators 241-246 for performing operations of the well construction system 100. Each subsystem 211-216 further includes various sensors 231-236 operable to generate sensor data indicative of operational performance and/or status of the wellsite equipment of each subsystem 211-216. Although the sensors 231-236 and actuators 241-246 are each shown as a single block, it is to be understood that each sensor 231-236 and actuator 241-246 may be or comprise a plurality of sensors and actuators, whereby each actuator performs a corresponding action of a piece of equipment or subsystem 211-216 and each sensor generates corresponding sensor data indicative of the action performed by a corresponding actuator or of other operational parameter of the piece of equipment or subsystem 211-216.

The local controllers 221-226, the sensors 231-236, and the actuators 241-246 may be communicatively connected with a processing device 202. For example, the local controllers may be in communication with the sensors 231-236 and actuators 241-246 of the corresponding subsystems 211-216 via local communication networks (e.g., field buses, not shown) and the processing device 202 may be in communication with the subsystems 211-216 via a communication network 209 (e.g., data bus, a wide-area-network (WAN), a local-area-network (LAN), etc.). The sensor data (e.g., electronic signals, information, and/or measurements, etc.) generated by the sensors 231-236 of the subsystems 211-216 may be made available for use by processing device 202 and/or the local controllers 221-226. Similarly, control commands (e.g., signals, information, etc.) generated by the processing device 202 and/or the local controllers 221-226 may be automatically communicated to the various actuators 241-246 of the subsystems 211-216, perhaps pursuant to predetermined programming, such as to facilitate well construction operations and/or other operations described herein. The processing device 202 may be or comprise the processing device 192 shown in FIG. 1. Accordingly, the processing device 202 may be communicatively connected with or form a portion of the workstation 197 and/or may be at least partially located within the control center 190.

The sensors 231-236 and actuators 241-246 may be monitored and/or controlled by the processing device 202. For example, the processing device 202 may be operable to receive the sensor data from the sensors 231-236 of the wellsite subsystems 211-216 in real-time, and to provide real-time control commands to the actuators 241-246 of the subsystems 211-216 based on the received sensor data. However, certain operations of the actuators 241-246 may be controlled by the local controllers 221-226, which may control the actuators 241-246 based on sensor data received from the sensors 231-236 and/or based on control commands received from the processing device 202.

The processing devices 188, 192, 202, the local controllers 221-226, and other controllers or processing devices of the well construction system 100 may be operable to receive program code instructions and/or sensor data from sensors (e.g., sensors 231-236), process such information, and/or generate control commands to operate controllable equipment (e.g., actuators 241-246) of the well construction system 100. Accordingly, the processing devices 188, 192, 202, the local controllers 221-226, and other controllers or processing devices of the well construction system 100 may individually or collectively be referred to hereinafter as equipment controllers. Equipment controllers within the scope of the present disclosure can include, for example, programmable logic controllers (PLCs), industrial computers (IPCs), personal computers (PCs), soft PLCs, variable frequency drives (VFDs) and/or other controllers or processing devices operable to receive sensor data and/or control commands and cause operation of controllable equipment based on such sensor data and/or control commands.

The various pieces of wellsite equipment described above and shown in FIGS. 1 and 2 may each comprise one or more hydraulic and/or electrical actuators, which when actuated, may cause corresponding components or portions of the piece of equipment to perform intended actions (e.g., work, tasks, movements, operations, etc.). Each piece of equipment may further comprise a plurality of sensors, whereby one or more sensors may be associated with a corresponding actuator or another component of the piece of equipment and communicatively connected with an equipment controller. Each sensor may be operable to generate sensor data (e.g., electrical sensor signals or measurements) indicative of an operational (e.g., mechanical, physical) status of the corresponding actuator or component, thereby permitting the operational status of the actuator to be monitored by the equipment controller. The sensor data may be utilized by the equipment controller as feedback data, permitting operational control of the piece of equipment and coordination with other equipment. Such sensor data may be indicative of performance of each individual actuator and, collectively, of the entire piece of wellsite equipment.

The present disclosure is further directed to systems and processes for validating or otherwise determining accuracy (i.e., quality) of sensor measurements in real-time while the sensors are utilized in the field (e.g., at oil and gas wellsite). Accuracy of sensor measurements may be determined by comparing such sensor measurements to other (e.g., alternative, backup) reference sensor measurements or to known reference measurements (e.g., quantities) under predetermined set of conditions or while responding to the same process within or across system(s). Relative differences or changes between the sensor measurements being validated and reference measurements may then be established and/or analyzed based on such comparisons, thereby facilitating the sensor measurements to be determined (e.g., validated, confirmed, deemed) as accurate within a certain degree of confidence. The sensor measurements and the reference measurements may be indicative of corresponding operational parameters (e.g., position, distance, length, speed, force, pressure, event status, etc.) performed by automated equipment. The sensor measurements, the reference measurements, and the operational parameters may be related to each other through context of common or related equipment and/or operations.

Accuracy of sensor measurements may be determined in real-time during wellsite operations by a wellsite monitoring and control system, such as the system 200, communicatively connected with or otherwise operable to receive and compare or otherwise analyze the sensor measurements and/or reference measurements. The control system may help identify anomalies among the sensor measurements during early stages before the sensor measurements degrade further. The control system may compensate for the identified anomalies thereby improving the quality of the sensor measurements, both for real-time use during wellsite operations and for post collection data analysis. The control system may also facilitate improved management of sensors and their state of health.

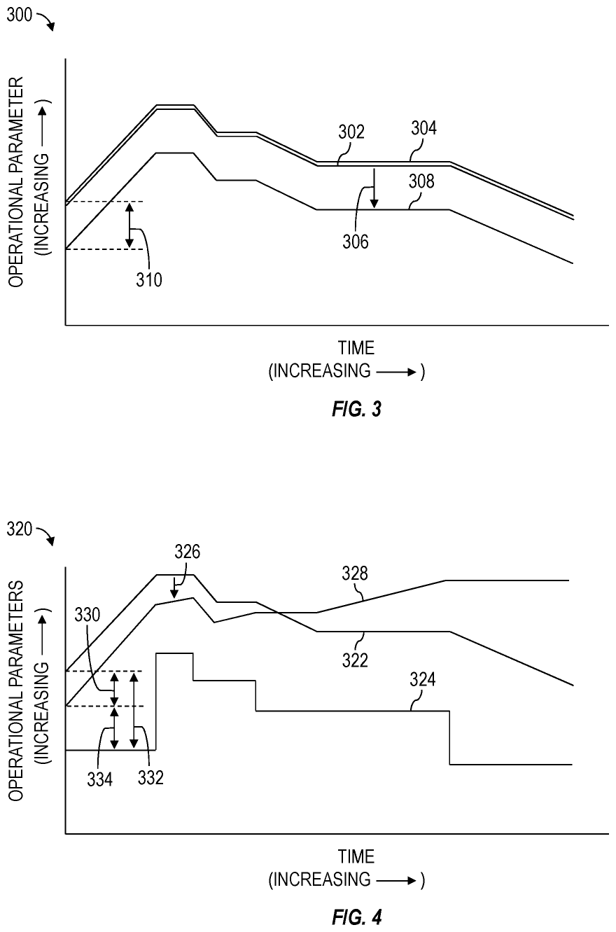

FIG. 3 is a graph 300 showing sensor measurements 302, 304 generated by corresponding sensors disposed in association with one or more pieces of wellsite equipment operating at a wellsite. The sensor measurements 302, 304 may be indicative of operational parameters (e.g., position, distance, speed, force, pressure, event status, etc.) associated with actions performed by corresponding one or more pieces of wellsite equipment. The sensor measurements 302, 304 may be indicative of the same or related operational parameters of the same or different pieces of equipment. When the sensors are disposed in association with different pieces of equipment, the equipment may be operatively (e.g., mechanically, fluidly, etc.) connected, such that one piece of equipment affects the other. The sensor measurements 302, 304 are plotted along the vertical axis, with respect to time, which is plotted along the horizontal axis.

A processing device, such as the processing device 202, may be operable to receive, record, and/or compare or otherwise analyze the sensor measurements 302, 304 periodically, continually, and/or in real-time during wellsite operations. For example, the processing device may compare the sensor measurements 302, 304 with each other. The processing device may then determine accuracy of the sensor measurements 302, 304 based on the comparison. For example, if the sensor measurements 302, 304 are substantially similar or match each other, then the sensor measurements 302, 304 and the corresponding sensors may be deemed or otherwise determined as being accurate, and thus validated. However, if one or both of the sensor measurements 302, 304 suddenly or progressively change (e.g., sensor measurements 302 shift, as indicated by arrow 306) resulting in sensor measurements 304, 308 that are not substantially similar or otherwise do not match, then at least one of the sensor measurements 304, 308 and the corresponding sensors may be deemed or otherwise determined as being inaccurate, and thus not valid. The sensor measurements 304, 308 may be determined as being inaccurate, for example, when a difference 310 (e.g., in profile and/or magnitude) between the sensor measurements 304, 308 is equal to or greater than a predetermined threshold amount or is otherwise appreciable. Each of the corresponding sensors and/or corresponding equipment may then be checked to determine which sensor is inaccurate or if another problem associated with the corresponding equipment is causing the difference 310 between the measurements 304, 308.

FIG. 4 is a graph 320 showing sensor measurements 322, 324 generated by corresponding sensors disposed in association with one or more pieces of wellsite equipment operating at a wellsite. Each of the sensor measurements 322, 324 may be indicative of corresponding operational parameters (e.g., position, distance, speed, force, pressure, event status, etc.) associated with actions performed by corresponding one or more pieces of wellsite equipment. The sensor measurements 322, 324 may be indicative of different, but related operational parameters of the same or different pieces of equipment. The sensor measurements 322, 324 are plotted along the vertical axis, with respect to time, which is plotted along the horizontal axis.

A processing device, such as the processing device 202, may be operable to receive, record, and/or compare or otherwise analyze the sensor measurements 322, 324 periodically, continually, and/or in real-time during wellsite operations. For example, the processing device may compare the sensor measurements 322, 324 with each other. The processing device may then determine accuracy of the sensor measurements 322, 324 based on the comparison. When the sensor measurements 322, 324 are indicative of different operational parameters and do not match, the processing device may receive, recognize, and/or establish a predetermined behavioral relationship 332 (e.g., association, correlation) between the operational parameters indicated by the sensor measurements 322 and the operational parameters indicated by the sensor measurements 324. The behavioral relationship 332 may be or comprise an expected, predicted, or established behavioral relationship between the sensor measurements 322, 324 during wellsite operations, such as a directly proportional relationship, an inversely proportional relationship, a direct relationship offset by a constant quantity, and/or other relationship. If the profile and/or magnitude of sensor measurements 322, 324 change with respect to each other or otherwise behave pursuant to the predetermined behavioral relationship 332, then the sensor measurements 322, 324 may be deemed or otherwise determined as being accurate, and thus validated. However, if one or both of the sensor measurements 322, 324 suddenly or progressively change (e.g., sensor measurements 322 shift, as indicated by arrow 326) resulting in sensor measurements 324, 328 that behave inconsistently with the predetermined behavioral relationship 332 (e.g., unexpectedly or unpredictably), then at least one of the sensor measurements 324, 328 and the corresponding sensors may be deemed or otherwise determined as being inaccurate, and thus not valid. The sensor measurements 324, 328 may be determined as being inaccurate, for example, when a difference 330 (e.g., in profile and/or magnitude) between the predetermined behavioral relationship 332 and an unexpected behavioral relationship 334 of the sensor measurements 324, 328 is equal to or greater than a predetermined threshold amount or is otherwise appreciable. Each of the corresponding sensors and/or corresponding equipment may then be checked to determine which sensor is inaccurate or if another problem associated with the corresponding equipment is causing the difference 330.

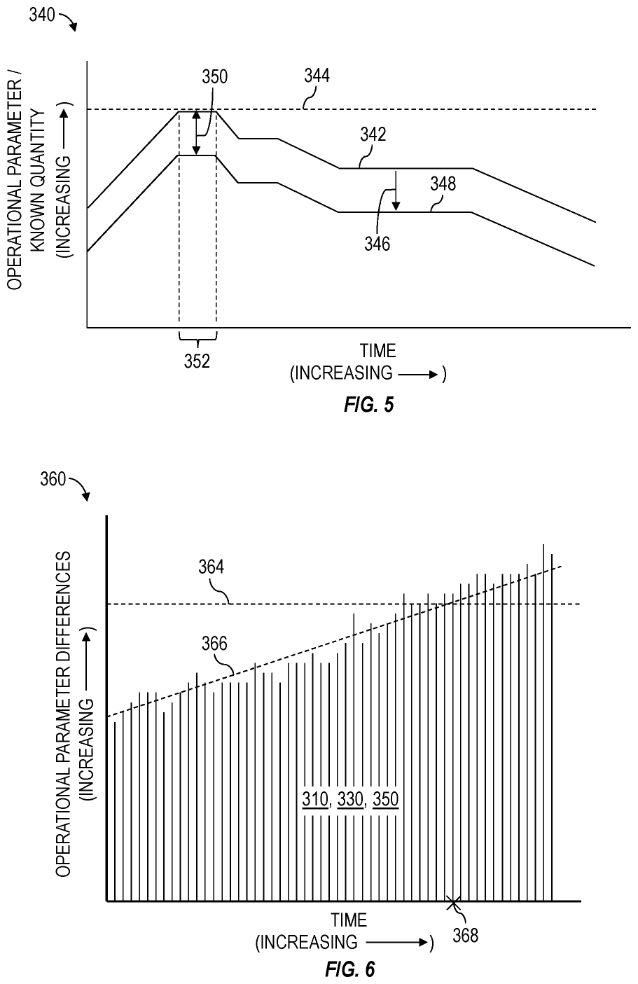

FIG. 5 is a graph 340 showing sensor measurements 342 generated by a corresponding sensor disposed in association with one or more pieces of wellsite equipment operating at a wellsite. The sensor measurements 342 may be indicative of operational parameters (e.g., position, distance, speed, force, pressure, event status, etc.) associated with actions performed by corresponding one or more pieces of wellsite equipment. The graph 340 further shows a known (i.e., actual) quantity 344 (i.e., measurement) associated with an element (e.g., a portion of a piece of wellsite equipment, a reference point at the wellsite, a structure at the wellsite, etc.) or operation performed by such element. The known quantity 344 may be indicative of a physical characteristic (e.g., weight, length, etc.) and/or operational parameter (e.g., position, etc.) of the element. The known quantity 344 may be determined by manually measuring such element or based on manufacturer drawings and/or other physical specifications of such element. The known quantity 344 may be fed into a processing device before and/or during the wellsite operations. The sensor measurements 342 and known quantity 344 may be indicative of the same or related element or operational parameter. The sensor measurements 342 and known quantity 344 are plotted along the vertical axis, with respect to time, which is plotted along the horizontal axis.

A processing device, such as the processing device 202, may be operable to receive, record, and/or compare or otherwise analyze the sensor measurement 348 with respect to the known quantity 344 periodically, continually, and/or in real-time during wellsite operations. For example, the processing device may compare the sensor measurement 342 to the known quantity 344 during a predetermined stage and corresponding time period 352 of wellsite operations when the sensor measurement 342 is intended to be equal to the known quantity 344. The processing device may then determine accuracy of the sensor measurement 342 based on the comparison. For example, if the sensor measurement 342 is substantially similar to or matches the known quantity 344 at the time period 352, then the sensor measurement 342 and the corresponding sensor may be deemed or otherwise determined as being accurate, and thus validated. However, if the sensor measurement 342 suddenly or progressively changes (e.g., sensor measurement 342 shifts, as indicated by arrow 346) resulting in sensor measurement 348 that is not substantially similar to or otherwise does not match the known quantity 344 at the time period 352, then the sensor measurement 348 and the corresponding sensor may be deemed or otherwise determined as being inaccurate, and thus not valid. The sensor measurement 348 may be determined as being inaccurate, for example, when a difference 350 (e.g., in profile and/or magnitude) between the known quantity 344 and the sensor measurement 348 is equal to or greater than a predetermined threshold amount or is otherwise appreciable. The determined sensor and/or corresponding equipment may then be checked to determine if such sensor is inaccurate or if another problem associated with the corresponding equipment is causing the difference 350 between the known quantity 344 and the sensor measurement 348.

FIG. 6 is a graph 360 showing a plurality measurement differences 310, 330, 350, as described above and shown individually in FIGS. 3-5, recorded over time. The graph 360 shows that the differences 310, 330, 350 are progressively increasing, which may indicate that the accuracy (i.e., quality) of the corresponding sensor measurements 302, 304, 322, 324, 342 (shown in FIGS. 3-5) is progressively decreasing. Such trend may be indicative of declining condition (i.e., health) of corresponding one or more sensors. The graph 360 may be generated by a processing device, such as the processing device 202, based on recorded historical and current operational parameter differences 310, 330, 350.

The processing device may generate or otherwise output condition information indicative of the health of the corresponding one or more sensors based on the measurement differences 310, 330, 350. For example, the processing device may output information indicative of which sensor and/or equipment comprises a problem. The processing device may also or instead output condition information indicative of remaining life of the corresponding one or more sensors. Furthermore, a threshold of acceptable condition, indicated by line 364, may be set. Accordingly, if a predetermined number of consecutive measurement differences 310, 330, 350 meet or exceed the threshold 364, such as at time 368, the processing device may at such time 368 output condition information suggesting or mandating that calibration or other maintenance of the corresponding one or more sensors and/or corresponding pieces of equipment be performed. Furthermore, if a running average of the measurement differences 310, 330, 350, indicated by line 366, meets or exceeds the threshold 364, such as at time 368, the processing device may at such time 368 output condition information suggesting or mandating that calibration or other maintenance of the corresponding one or more sensors and/or corresponding pieces of equipment be performed.

Thus, when the processing device does not detect measurement differences 310, 330, 350 over a predetermined period of time, the processing device may determine that the sensor measurements 302, 304, 322, 324, 342 and, thus, the corresponding sensors are accurate. However, when the processing device detects sudden or progressive onset of measurement differences 310, 330, 350, the processing device may determine that the sensor measurements 302, 304, 322, 324, 342 and, thus, the corresponding sensors are inaccurate. The inaccurate sensor measurements 304, 308, 324, 428, 348 may be disregarded until the corresponding sensors are replaced or recalibrated. The inaccurate sensor measurements 304, 308, 324, 428, 348 may also or instead be compensated by a predetermined value, such as by the detected difference 310, 330, 350 until the corresponding sensors are replaced or recalibrated.

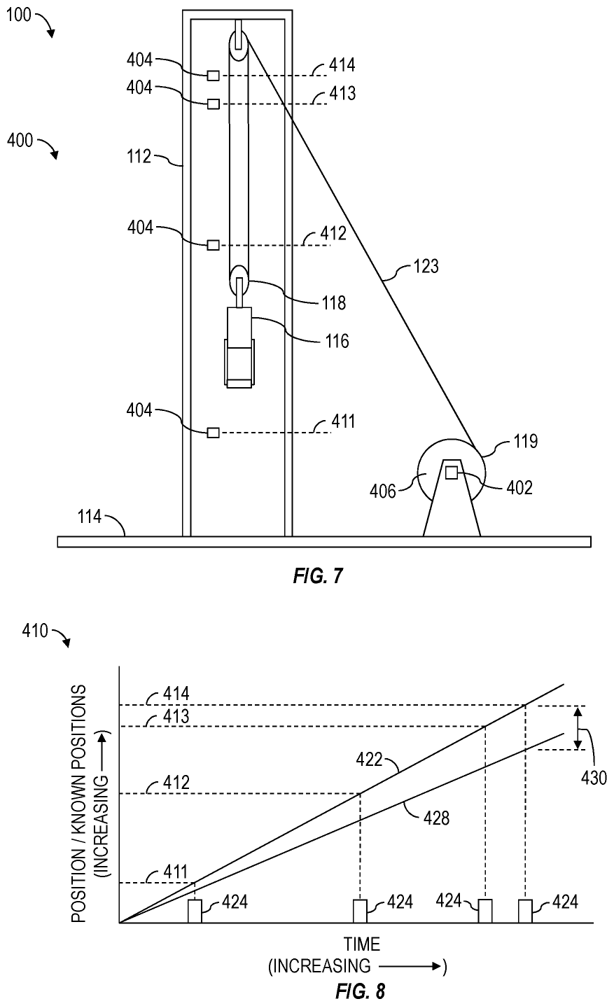

FIG. 7 is a schematic view of an example implementation of a wellsite system 400 comprising a plurality of sensors 402, 404 operable to generate sensor measurements indicative of corresponding operational parameters of equipment at a wellsite according to one or more aspects of the present disclosure. The wellsite system 400 may be operable to validate or otherwise determine accuracy of sensor measurements indicative of block position of tubular hoisting equipment based sensor measurements indicative of hoisting equipment passing flag positions located along a support structure (e.g., mast) at the wellsite. The wellsite system 400 may comprise one or more features of the well construction system 100 shown in FIG. 1 and the control system 200 shown in FIG. 2, including where indicated by the same numerals. The wellsite system 400 may also be operable to perform processes described above in association with FIGS. 3-6. Accordingly, the following description refers to FIGS. 1-7, collectively.

The wellsite system 400 may comprise a draw works 119 and one or more sensors 402 disposed in association with the draw works 119, such as may permit the sensors 402 to generate sensor measurements (e.g., electrical sensor signals or data) indicative of rotational position of a drum 406 of the draw works 119. Such sensor measurements may be further indicative of block position, which may be or comprise position of a traveling block 118 or other hoisting equipment (e.g., top drive 116) supported by the traveling block 118. The wellsite system 400 may further comprise a support structure 112 supporting the travelling block 118 and a plurality of sensors 404, each located at a predetermined or otherwise known reference position 411-414 (i.e., height) along the support structure 112. The known positions 411-414 may be known as flags or targets. Each sensor 404 may be operable to generate sensor signals indicative of presence or proximity of the travelling block 118 or other hoisting equipment supported by the traveling block 118 when the traveling block 118 other equipment passes the sensor 404, thereby indicating the known position 411-414 of the traveling block 118 at a particular time. The sensors 402 may be or comprise, for example, encoders, rotary potentiometers, and rotary variable-differential transformers (RVDTs), and the sensors 404 may be or comprise, for example, proximity sensors and Hall effect sensors.

A processing device, such as the processing device 202, may be operable to receive, record, and/or compare or otherwise analyze the sensor measurements (e.g., data) generated by the sensors 402, 404 periodically, continually, and/or in real-time during wellsite operations. FIG. 8 is a graph 410 showing sensor measurements 422 generated by the sensors 402 indicative of block position of the traveling block 118 while the drum 406 of the draw works 119 rotates. The graph further shows known positions 411-414 of the travelling block 118 when the travelling block 118 passes each corresponding sensor 404 thereby causing each sensor 404 to generate a corresponding sensor signal 424. The sensor measurements 422 and known positions 411-414 are plotted along the vertical axis, with respect to time, which is plotted along the horizontal axis. The block position based on the sensor measurements 422 is shown as a progressively increasing profile or curve indicative of an increasing position (e.g., height) of the traveling block 118 while the drum 406 of the draw works 119 rotates. The known positions 411-414 are shown as a plurality of horizontal lines indicative of actual measured heights of the traveling block 118 as the travelling block 118 passes each sensor 404 causing each sensor 404 to generate a discrete signal 424 indicative of a corresponding known position 411-414. The known positions 411-414 associated with each sensor 404 may be fed into a processing device before and/or during the wellsite operations.

During wellsite operations (e.g., drilling operations), the processing device may continually and/or in real-time compare the sensor measurements 422 with the known positions 411-414 when the processing device receives the sensor signals 424 when the traveling block 118 passes each corresponding sensor 404. The processing device may determine accuracy of the sensor measurements 422 generated by the sensors 402 based on the comparison with the known positions 411-414. For example, the processing device may recognize or establish a relationship (e.g., association, correlation) between the sensor measurements 422 and the known positions 411-414. If the block position indicated by the sensor measurements 422 generated by sensor 402 matches the known positions 411-414 at substantially the same time corresponding sensor signals 424 are generated when the traveling block 118 passes the sensors 404, then the sensor measurements 425 and the corresponding sensors 402 may be deemed or otherwise determined as accurate, and thus validated. However, if the sensor measurements 422 shift or change, resulting in changed sensor measurements 428, such that the measured block position height differs 430 or otherwise does not match the known positions 411-414 at substantially the same time the traveling block 118 passes the sensors 404, then the changed sensor measurements 428 and the corresponding sensors 402 may be determined as inaccurate, and thus not valid. The sensor measurements 422, 428 and the block position measurement differences 430 may be recorded and compared over time. The sensor measurements 428 generated by the sensors 402 may be determined as inaccurate, for example, when the recorded differences 430 between the sensor measurements 428 and the known positions 411-414 suddenly or progressively shift or change over time by at least a predetermined threshold amount.

Validation of accuracy of block position measurements may be performed while the drill rig is operating in a loaded state, such as when the travelling block 118 of the hoisting equipment is supporting a tubular (e.g., a drill pipe), and/or while the drill rig is operating in an unloaded state, such as when the travelling block 118 is not supporting a tubular. However, such validation process has to be consistently performed by accounting for the load state of the drill rig. For example, in the loaded drill rig state, the support line 123 may be stretched compared to when the drill rig is operating in an unloaded state. Thus, block position measurements generated by the sensors 402 while the drill rig is operating in an unloaded state may not be compared to block position measurements generated by the sensors 402 while the drill rig is operating in a loaded state because each set of sensor measurements is indicative of a different position when the traveling block 118 passes the sensors 404.

FIG. 9 is a schematic view of an example implementation of a wellsite system 500 comprising a plurality of sensors 502, 504 operable to generate sensor measurements indicative of corresponding operational parameters of equipment at a wellsite. According to one or more aspects of the present disclosure, the wellsite system 500 may be operable to validate or otherwise determine accuracy of sensor measurements indicative of hook load of tubular hoisting equipment. The wellsite system 500 may comprise one or more features of the well construction system 100 shown in FIG. 1 and the control system 200 shown in FIG. 2, including where indicated by the same numerals. The wellsite system 500 may also be operable to perform processes described above in association with FIGS. 3-6. Accordingly, the following description refers to FIGS. 1-6 and 9, collectively.

The wellsite system 500 may comprise a top drive 116 supported by a traveling block 118 operatively connected with and collectively raised by a draw works 119 (shown in FIG. 1) via a support line 123. The top drive 116 may be connected with the travelling block 118 via a hook 505 and plurality (e.g., two, four) of tie rods 506 extending between the hook 505 and the top drive 116. The wellsite system 500 may utilize four tie rods 506, with two tie rods 506 being obstructed from view. Each tie rod 506 may carry or comprise a corresponding load sensor 502 operable to generate sensor measurements indicative of tension applied to and, thus, weight supported by each tie rod 506. The support line 123 may be stored on a storage reel 508 and tied down by a deadline anchor 510, which may carry or comprise a load sensor 504 operable to generate sensor measurements indicative of tension applied to and, thus, weight supported by the support line 123. The sensor measurements generated by the load sensor 504 and collectively, the load sensors 502, may be indicative of the hook load of the hoisting system. The load sensors 502, 504 may be or comprise, for example, strain gauges and/or load cells.

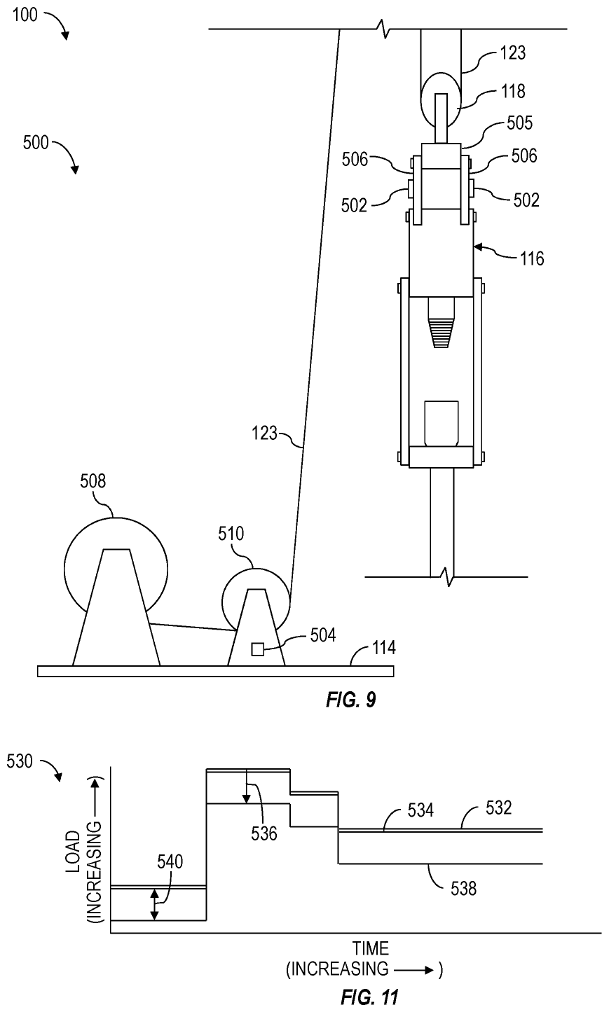

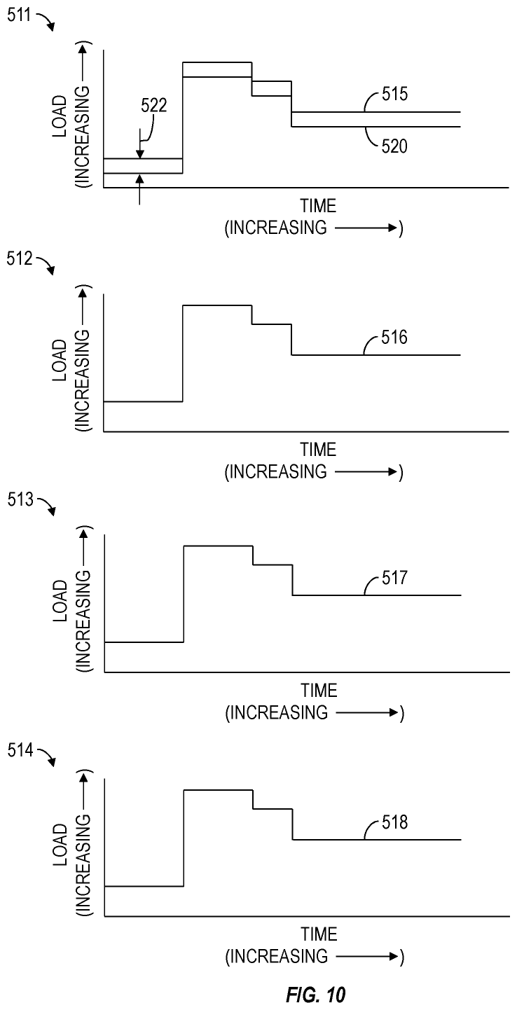

A processing device, such as the processing device 202, may be operable to receive, record, and/or compare or otherwise analyze the sensor measurements generated by the sensors 502, 504 periodically, continually, and/or in real-time during wellsite operations. FIG. 10 is a plurality of graphs 511-514, each showing sensor measurements 515-518 generated by a corresponding sensor 502 indicative of load (e.g., tension, weight) supported by a corresponding tie rod 506, plotted along the vertical axis, with respect to time, which is plotted along the horizontal axis. The sensor measurements 515-518 are shown changing in a similar manner with respect to time while the wellsite system 500 progresses through various stages of wellsite operations.

During wellsite operations (e.g., drilling operations), the processing device may compare each sensor measurement 515-518 generated by a corresponding sensor 502 with the other of the sensor measurements 515-518. The processing device may then determine accuracy of each sensor measurement 515-518 based on the comparison with the other of the sensor measurements 515-518 over time. For example, if the load profile indicated by the sensor measurements 515 (validated sensor measurements) generated by a corresponding sensor 502 is substantially similar to or otherwise matches the load profile indicated by the other sensor measurements 516-518 (reference sensor measurements), as shown in graphs 511-514, then the sensor measurements 515 and the corresponding sensor 502 may be deemed or otherwise determined as accurate, and thus validated. However, if the sensor measurements 515 shift or change, resulting in sensor measurements 520 that differ or otherwise do not match the profiles and/or magnitudes of the sensor measurements 516-518 by a measured amount 522, then the changed sensor measurements 520 and the corresponding sensor 502 may be determined as inaccurate. The sensor measurements 515-518, 520 generated by the sensors 502 may be recorded and compared over time. The changed sensor measurements 520 and the corresponding sensor 502 may be determined as inaccurate, for example, when the recorded differences 522 between the sensor measurements 520 and the sensor measurements 516-518 suddenly or progressively shift or change over time by at least a predetermined threshold amount.

FIG. 11 is a graph 530 showing sensor measurements 532, 534 indicative of hook load supported by hoisting equipment of the wellsite system 500, plotted along the vertical axis, with respect to time, which is plotted along the horizontal axis. The sensor measurements 532 may be or comprise the sum of the sensor measurements 515-518 generated by the sensors 502 and the sensor measurements 534 may be generated by the sensor 504 of the deadline anchor 510.

During wellsite operations, the processing device may periodically, continually, and/or in real-time compare the sensor measurements 532, 534 with each other. The processing device may determine accuracy of the sensor measurements 532, 534 based on the comparison of the sensor measurements 532, 534 over time. For example, if the profile and/or magnitude of the sensor measurements 532, 534 are substantially similar or otherwise match each other, as shown in graph 530, then the sensor measurements 532, 534 and the corresponding sensors 502, 504 may be deemed or otherwise determined as accurate, and thus validated. However, if one or both of the sensor measurements 532, 534 suddenly or progressively change (e.g., sensor measurements 532 shift, as indicated by arrow 536) resulting in sensor measurements 534, 538 that are not substantially similar or otherwise do not match, then at least one of the sensor measurements 534, 538 and the corresponding sensors 502, 504 may be deemed or otherwise determined as being inaccurate, and thus not valid. The sensor measurements 534, 538 may be determined as being inaccurate, for example, when a difference 540 (e.g., in profile and/or magnitude) between the sensor measurements 534, 538 is equal to or greater than a predetermined threshold amount. Each of the corresponding sensors 502, 504 and/or corresponding equipment may then be checked to determine which sensor is inaccurate or if another problem associated with the corresponding equipment is causing the difference 540 between the measurements 534, 538.

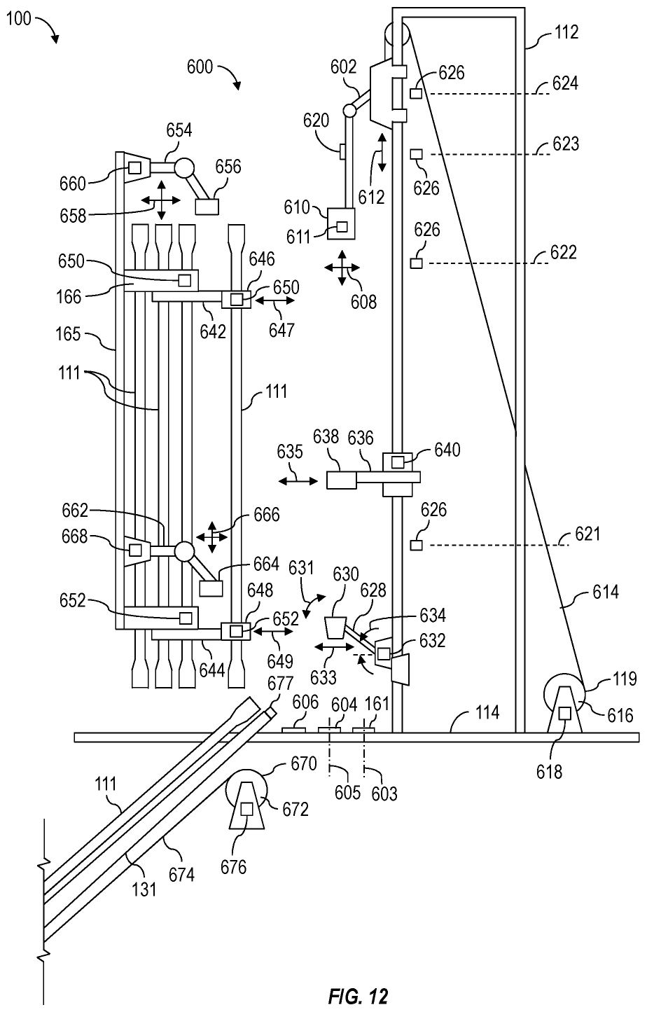

FIG. 12 is a schematic view of an example implementation of a wellsite system 600 comprising a plurality of pipe handling equipment, each comprising or carrying one or more sensors operable to generate sensor measurements indicative of corresponding operational parameters of such equipment. According to one or more aspects of the present disclosure, the wellsite system 600 may be operable to validate or otherwise determine accuracy of selected sensor measurements based on other sensor measurements or known quantities (e.g., manual or physical measurements) at the wellsite. The wellsite system 500 may comprise one or more features of the well construction system 100 shown in FIG. 1 and the control system 200 shown in FIG. 2, including where indicated by the same numerals. The wellsite system 500 may also be operable to perform processes described above in association with FIGS. 3-6. Accordingly, the following description refers to FIGS. 1-6 and 12, collectively.

The wellsite system 600 may comprise a wellsite structure 112 supporting various automated pipe handling equipment operable to transport tubulars 111 (e.g., drill pipes, stands of drill pipe, casing joints) between different areas of the wellsite system 600. The wellsite system 600 may further comprise a catwalk 131 operable to transport tubulars 111 from a storage area at a ground level, such as the wellsite surface 104 (shown in FIG. 1), to a rig floor 114. The wellsite structure 112 or another portion of the wellsite system 600 may support a setback 165 and a delivery arm 602 (e.g., a tubing delivery arm (TDA)) operable to grab the tubulars 111, one at a time, from the fingerboard 166 and/or the catwalk 131 and lift or otherwise move the tubulars 111 to predetermined positions.

For example, the delivery arm 602 may move a tubular 111 over the wellbore, such that the tubular 111 is aligned with the wellbore center 603 above the reciprocating slips 161. The delivery arm 602 may also move a tubular 111 over a mouse hole 604, such that the tubular 111 is aligned with the mouse hole center 605, permitting one or more tubulars 111 to be disposed therein such that two or more tubulars 111 can be coupled together to form a stand. The delivery arm 602 may also move a tubular 111 to a doping stand or area 606, such that the tubular 111 may be greased or otherwise prepared for make-up operations. Portions of the delivery arm 602 may be operable to move horizontally and/or vertically, as indicated by arrows 608, such as may permit a grabber or clamp 610 of the delivery arm 602 to grab or otherwise receive a tubular 111 being transferred from the pipe rack on the ground to the rig floor 114 by the catwalk 131. A draw works 119 may be operable to move the delivery arm 602 vertically along the support structure 112, as indicated by arrows 612. The draw works 119 may be operatively connected with the delivery arm 602 via a support line 614 extending between the delivery arm 602 and a drum 616 of the draw works 119.

One or more sensors 611 may be disposed in association with the clamp 610, such as may permit the sensor 611 to generate sensor signals indicative of presence or proximity of a tubular 111 received by the clamp 610. One or more sensors 618 may be disposed in association with the draw works 119, such as may permit the sensor 618 to generate sensor measurements (e.g., electrical sensor signals or data) indicative of rotational position of the drum 616. Such sensor measurements may be further indicative of vertical position of the delivery arm 602 along the support structure 112. The delivery arm 602 may carry or comprise one or more sensors 620 operable to generate sensor measurements indicative of tension applied to and, thus, weight supported by the delivery arm 602. The support structure 112 may further support a plurality of sensors 626, each located at a predetermined or otherwise known reference position 621-624 (i.e., height) along the support structure 112. Such known reference positions 621-624 may be known in the oil and gas industry as flags or targets. Each sensor 626 may be operable to generate a sensor signal indicative of presence or proximity of the delivery arm 602 when the delivery arm 602 passes the sensor 626, thereby indicating a corresponding known position 621-624 of the delivery arm 602 at such time.

The wellsite structure 112 or another portion of the wellsite system 600 may further support a stabilization arm 628 (e.g., a lower stabilization arm (LSA)) operable to receive (e.g., catch) a tubular 111 supported by the delivery arm 602 via a holding device 630, stabilize the tubular 111, and/or pivot 631 to horizontally move 633 the tubular 111 to align the tubular 111 with the wellbore center 603, the mouse hole center 605, or the doping area 606. The stabilization arm 628 may carry or comprise one or more sensors 632 operable to generate sensor measurements indicative of stabilization arm extension (i.e., length) and/or angle 634 between the stabilization arm 628 and the support structure 112 or a reference plane.

The wellsite structure 112 or another portion of the wellsite system 600 may further support an intermediate positioner 636 (e.g., an intermediate constraint) operable to grab a tubular 111 supported by the delivery arm 602 via a grabber or clamp 638, stabilize the tubular 111, and/or horizontally move 635 the tubular 111 to align the tubular 111 with the mouse hole center 605 or the doping area 606. The intermediate positioner 636 may carry or comprise one or more sensors 640 operable to generate sensor measurements indicative of extension or horizontal position 635 of the clamp 638.

The support structure 112, the setback 165, or another portion of the wellsite system 600, such as the PHM 163 shown in FIG. 1, may support an upper positioner 642 (e.g., an upper constraint) and a lower positioner 644 (e.g., a lower constraint) each operable to grab a corresponding upper and lower portion of a tubular 111 via a corresponding grabber or clamp 646, 648. The positioners 642, 644 may stabilize the tubular 111 and/or horizontally move the corresponding upper and/or lower portions of the tubular 111, as indicated by arrows 647, 649, to align the tubular 111 with the mouse hole center 605, or the doping area 606. The upper and lower positioners 642, 644 may each carry or comprise one or more corresponding sensors 650, 652 operable to generate sensor measurements indicative of extension or horizontal positions 647, 649 of the corresponding clamps 646, 648.

The support structure 112, the setback 165, or another portion of the wellsite system 600 may further support a racker 654 (e.g., a transfer bridge racker (TBR)) and a guide arm (e.g., a setback guide arm (SGA)) 662 collectively operable to store (e.g., hang, rack) the tubulars 111 in a fingerboard 166 of the setback 165. For example, the racker 654 may be operable to grab an upper portion of a tubular 111 via a grabber or clamp 656 and move the tubular 111 horizontally and/or vertically between the fingerboard 166 and the wellbore center 603, as indicated by arrows 658. The racker 654 may carry or comprise one or more corresponding sensors 660 operable to generate sensor measurements indicative of the horizontal and/or vertical position 658 of the clamp 656. The guide arm 662 may be operable to grab a lower portion of the tubular 111 via a grabber or clamp 664 and move the lower portion of the tubular 111 horizontally and/or vertically between the fingerboard 166 and the wellbore center 603, as indicated by arrows 666, in unison (i.e., synchronously) with the racker 654. The guide arm 662 may carry or comprise one or more corresponding sensors 668 operable to generate sensor measurements indicative of the horizontal and/or vertical position 666 of the clamp 664.

The catwalk 131 may comprise a skate 133 (shown in FIG. 1) movable along a groove (not shown) extending longitudinally along the catwalk 131. The skate 133 may be driven along the groove by a drive system 670, such as a winch system comprising a spool 672 driven by a motor (not shown). The drive system 670 may be selectively operable to pull the skate 133 in opposing directions along the catwalk 131 via a line 674 extending between the spool 672 and the skate 133. Actuated by the drive system 670, the skate 133 may be operable to convey (e.g., push) a tubular 111 along the catwalk 131 to the rig floor 114. The skate 133 may move the box end of the tubular 111 into the clamp 610 of the delivery arm 602, such that the tubular 111 can be lifted by the delivery arm 602. The drive system 670 may carry or comprise one or more corresponding sensors 676 operable to generate sensor measurements indicative of rotational position of the spool 672 and, thus, position of the skate 133 along the catwalk 131.

The sensors 618, 676 may be or comprise, for example, encoders, rotary potentiometers, and/or rotary variable-differential transformers (RVDTs). The sensors 620 may be or comprise, for example, strain gauges and/or load cells. The sensors 611, 626 may be or comprise, for example, proximity sensors and Hall effect sensors. The sensors 632, 640, 650, 652, 660, 668 may be or comprise, for example, encoders, rotary potentiometers, linear potentiometers, or rotary variable-differential transformers (RVDTs).

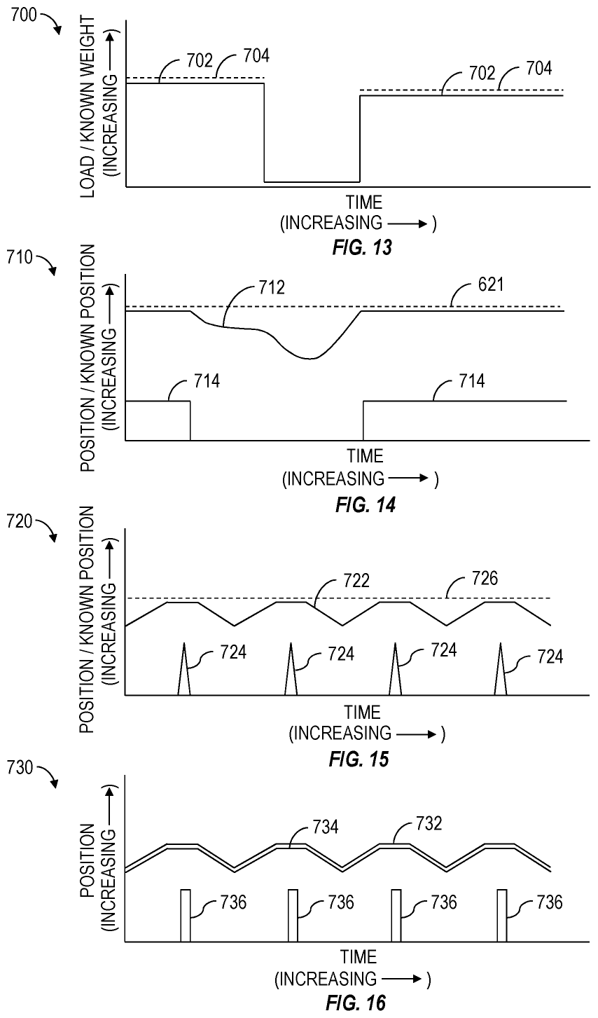

FIG. 13 is a graph 700 showing sensor measurements 702 generated by the sensor 620 indicative of a load (i.e., weight) supported by the delivery arm 602 of the wellsite system 600. The graph 700 further shows a known (e.g., actual, physically measured) weights 704 of tubulars supported by the delivery arm 602. The sensor measurements 702 may be compared to the known weights 704 of the tubulars carried by the delivery arm 602 to validate the accuracy of the sensor 620. The sensor measurements 702 and the known weights 704 are plotted along the vertical axis, with respect to time, which is plotted along the horizontal axis.

The known weight 704 of a tubular may be determined by multiplying the length of the tubular by the weight per unit length (e.g., pounds per foot) of the tubular. The length of the tubular may be known based on number of discrete portions (e.g., drill pipes) the tubular comprises and actual (e.g., manual) measurements taken of the tubular. The known length and/or weight 704 of each tubular may be known based on manufacturer specifications and/or based on manual and/or sensor measurements taken before the tubular is moved by the delivery arm 602. Thus, the known weight 704 of each tubular may be or comprise measurements indicative of the weight of the tubular taken before the tubular is moved by the delivery arm 602. The known weights 704 of the tubulars may be fed into a processing device before and/or during the wellsite operations.

During wellsite operations (e.g., drilling operations, stand building operations), a processing device, such as the processing device 202, may continually and/or in real-time compare the sensor measurements 702 generated by the sensors 620 with the known weight 704 of each tubular carried by the delivery arm 602. The processing device may determine accuracy of the sensor measurements 702 based on the comparison with the known weight 704 while each successive tubular is moved by the delivery arm 602. For example, if the magnitude of the sensor measurements 702 is substantially similar to or otherwise matches the known weight 704 of the tubular while each tubular is picked up, as shown in graph 700, then the sensor measurements 702 and the corresponding sensor 620 may be deemed or otherwise determined as accurate, and thus validated. However, if the sensor measurements 702 shift or change, resulting in sensor measurements 702 that differ or otherwise do not match the magnitude of the known weight 704 by a measured amount, then the changed sensor measurements 702 and the corresponding sensor 620 may be determined as inaccurate. The sensor measurements 702 generated by the sensor 620, the known weight 704, and the determined differences may be recorded and compared over time. The changed sensor measurements 702 and the sensor 620 may be determined as inaccurate, for example, when the recorded differences suddenly or progressively shift or change over time by at least a predetermined threshold amount with respect to the known weights 704.

FIG. 14 is a graph 710 showing sensor measurements 712 generated by the sensor 618 indicative of vertical position 612 of the delivery arm 602 while the drum 616 of the draw works 119 rotates. The graph further shows the known position 621 of the known positions 621-624 associated with the sensors 626. During operations, each sensor 626 is operable to generate a corresponding sensor signal 714 when the delivery arm 602 passes each corresponding sensor 626. The sensor measurements 712 and known position 621 are plotted along the vertical axis, with respect to time, which is plotted along the horizontal axis. The sensor measurements 712 are shown as a profile or curve indicative of a changing vertical position (e.g., height) of the delivery arm 602 while the drum 616 of the draw works 119 rotates. The known position 621 is shown as a horizontal line indicative of the actual measured height of the delivery arm 602 when the delivery arm 602 passes a corresponding sensor 626, thereby causing the sensor 626 to generate a discrete signal 714 indicative of the corresponding known position 621. The known positions 621-624 associated with each sensor 626 may be fed into the processing device before and/or during the wellsite operations.

During wellsite operations, the processing device may continually and/or in real-time compare the sensor measurements 712 with the known positions 621-624 when the processing device receives the sensor signals 714 when the delivery arm 602 passes each corresponding sensor 626. The processing device may determine accuracy of the sensor measurements 712 based on the comparison with the known positions 621-624. For example, the processing device may recognize or establish a relationship (e.g., association, correlation) between the sensor measurements 712 and the known positions 621-624. If the position of the delivery arm 602 indicated by the sensor measurements 712 generated by the sensor 618 matches the known positions 621-624 at substantially the same time corresponding sensor signals 714 are generated when the delivery arm 602 passes the sensors 626, then the sensor measurements 712 and the corresponding sensor 618 may be deemed or otherwise determined as accurate, and thus validated. However, if the sensor measurements 712 shift or change, resulting in changed sensor measurements, such that the position of the delivery arm 602 measured by the sensor 618 differs or otherwise does not match one or more of the known positions 621-624 at substantially the same time the delivery arm 602 passes each sensor 626, then the changed sensor measurements 712 and the corresponding sensor 618 may be determined as inaccurate, and thus not valid. The measurement differences may be recorded and compared over time. The sensor measurements 712 generated by the sensor 618 may be determined as inaccurate, for example, when the recorded differences between the sensor measurements 712 and the known positions 621-624 suddenly or progressively shift or change over time by at least a predetermined threshold amount.

FIG. 15 is a graph 720 showing sensor measurements 722 generated by sensor 632 indicative of horizontal position (e.g., distance from a reference point) of the holding device 630 of the stabilization arm 628 and sensor measurements 724 generated by sensor 152 indicative of torque applied by the iron roughneck 151 to make up or break out connections between tubulars. The graph 720 further shows a known (i.e., actual) position 726 (e.g., with respect to a reference point, such as the wellsite structure 112) of the wellbore center 603. The sensor measurements 722, 724 and the known position 726 are plotted along the vertical axis, with respect to time, which is plotted along the horizontal axis. The sensor measurements 722 may be compared to the known position 726 of the wellbore center 603 while the iron roughneck 151 is applying torque to a tubular during make-up or break-out operations.

The sensor measurements 722 are shown as a changing profile or curve indicative of a changing horizontal position of the stabilization arm 628 while the tubulars are aligned with the well center 603 and the iron roughneck 151 applies torque 724 to make up or break out tubular connections. The horizontal position of the holding device 630 indicated by the sensor measurements 722 may be calculated or otherwise determined based on length (e.g., telescopic extension) and the angle 634 of the stabilization arm 628. For example, the horizontal position 722 may be calculated by multiplying the length of the stabilization arm 628 by cosine of the angle 634 of the stabilization arm 628. The sensor measurements 724 are shown as a plurality of spikes, each indicative of torque applied by the iron roughneck 151 while the stabilization arm 628 is holding a lower portion of a tubular. The known position 726 of the wellbore center 603 may be determined by manually measuring such position 726 with respect to the reference point or based on manufacturer drawings and/or other physical specifications of the wellsite system 600. The known position 726 may be fed into the processing device before or during the wellsite operations.

During wellsite operations, the processing device may continually and/or in real-time compare the sensor measurements 722 with the known position 726. The processing device may determine accuracy of the sensor measurements 722 based on the comparison with the known position 726 while the iron roughneck 151 is applying torque 724 to each successive tubular, indicating that the holding device 630 of the stabilization arm 628 is horizontally aligned with the wellbore center 603 and, thereby, at the known position 726 of the wellbore center 603. For example, if the magnitude of the sensor measurements 722 is substantially similar to or otherwise matches the known position 726 of the wellbore center 603 while torque 724 is applied, as shown in graph 720, then the sensor measurements 722 and the corresponding sensor 632 may be deemed or otherwise determined as accurate, and thus validated. However, if the sensor measurements 722 shift or change, resulting in sensor measurements that differ or otherwise do not match the magnitude of the known position 726 by a measured amount, then the changed sensor measurements 722 and the sensor 632 may be determined as inaccurate. The sensor measurements 722 generated by the sensor 632 and the known position 726 may be recorded and compared over time. The changed sensor measurements 722 and the corresponding sensor 632 may be determined as inaccurate, for example, when the recorded differences suddenly or progressively shift or change over time by at least a predetermined threshold amount with respect to the known position 726.

FIG. 16 is a graph 730 showing sensor measurements 732 generated by sensor 650 indicative of horizontal position (e.g., distance from a reference point) of the clamp 646 of the upper positioner 642, sensor measurements 734 generated by sensor 652 indicative of horizontal position of the clamp 648 of the lower positioner 644, and sensor measurements 736 generated by sensor 611 indicative of a tubular being positioned within the clamp 610 of the delivery arm 602. The sensor measurements 732, 734, 736 are plotted along the vertical axis, with respect to time, which is plotted along the horizontal axis. The sensor measurements 732, 734 may be compared to each other to validate each other while the tubular is being positioned within the clamp 610 of the delivery arm 602.

The sensor measurements 732, 734 are each shown as a changing profile or curve indicative of a changing horizontal position of the clamps 646, 648 of the upper and lower positioners 642, 644, respectively, while the tubulars are aligned with the mouse hole center 605 and the delivery arm 602. The horizontal position of the clamps 646, 648 may be calculated or otherwise determined based on length (e.g., telescopic extension) of the upper and lower positioners 642, 644. The sensor measurements 736 are shown as a plurality of spikes, each indicative of tubular is being positioned within the clamp 610 of the delivery arm 602 while the clamps 646, 648 are holding opposing portions of a tubular in alignment with the mouse hole center 605.

During wellsite operations, the processing device may continually and/or in real-time compare each of the sensor measurements 732, 734 with the other of the sensor measurements 732, 734. The processing device may determine accuracy of each sensor measurement 732, 734 based on the comparison with the other of the sensor measurement 732, 734 while tubular is being positioned within the clamp 610 of the delivery arm to each successive tubular, indicating that the clamps 646, 648 of the upper and lower positioners 642, 644 are horizontally aligned with the mouse hole center 605. For example, if the magnitudes of the sensor measurements 732, 734 are substantially similar to or otherwise match each other while the tubing is clamped in the deliver arm 736, as shown in graph 730, then the sensor measurements 732, 734 and the corresponding sensors 650, 652 may be deemed or otherwise determined as accurate, and thus validated. However, if one or both of the sensor measurements 732, 734 shift or change, resulting in sensor measurements 732, 734 that differ or otherwise do not match each other by a measured amount, then one or both of the sensor measurements 732, 734 and the corresponding sensors 650, 652 may be determined as inaccurate. The difference between the sensor measurements 732, 734 may be recorded and compared over time. The sensor measurements 732, 734 and the corresponding sensors 650, 652 may be determined as inaccurate, for example, when the recorded differences suddenly or progressively shift or change over time by at least a predetermined threshold amount.

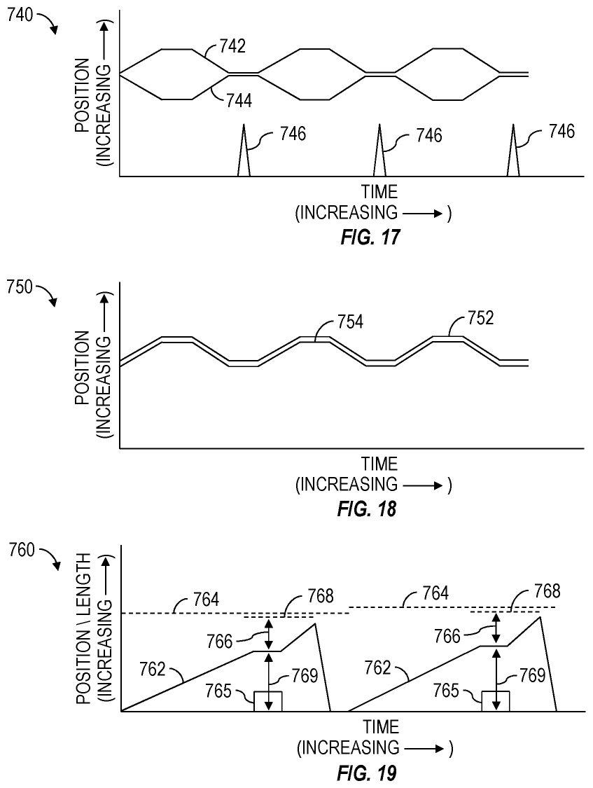

FIG. 17 is a graph 740 showing sensor measurements 742 generated by sensor 652 indicative of horizontal position (e.g., distance from a reference point) of the clamp 648 of the lower positioner 644, sensor measurements 744 generated by sensor 640 indicative of horizontal position of the clamp 638 of the intermediate positioner 636, and sensor measurements 746 generated by sensor 152 indicative of torque applied by the iron roughneck 151 to make up connections between tubulars held by the clamps 648, 638 during stand building operations. The sensor measurements 742, 744, 746 are plotted along the vertical axis, with respect to time, which is plotted along the horizontal axis. The sensor measurements 742, 744 may be compared to each other to validate each other while the iron roughneck 151 is applying torque to a tubular during stand building operations.

The sensor measurements 742, 744 are each shown as a changing profile or curve indicative of a changing horizontal position of the clamps 648, 638 of the lower and intermediate positioners 644, 636, respectively, while each tubular is aligned with the mouse hole center 605 and the iron roughneck 151 applies torque to make up tubular connections. The horizontal position of the clamps 648, 638 may be calculated or otherwise determined based on length (e.g., telescopic extension) of the lower and intermediate positioners 644, 636. The sensor measurements 746 are shown as a plurality of spikes, each indicative of torque applied by the iron roughneck 151 while the clamps 648, 638 are holding corresponding portions of a tubular.

During wellsite operations (e.g., stand building operations), the processing device may continually and/or in real-time compare each of the sensor measurements 742, 744 with the other of the sensor measurements 742, 744. The processing device may determine accuracy of each sensor measurement 742, 744 based on the comparison with the other of the sensor measurement 742, 744 while the iron roughneck 151 is applying torque 746 to a tubular, indicating that the clamps 648, 638 of the lower and intermediate positioners 644, 636 are horizontally aligned (i.e., in the same horizontal position) with the mouse hole center 605. For example, if the horizontal positions of the clamps 648, 638 indicated by the sensor measurements 742, 744 are substantially the same each time the torque 746 is applied, as shown in graph 740, then the sensor measurements 742, 744 and the corresponding sensors 652, 640 may be deemed or otherwise determined as accurate, and thus validated. However, if one or both of the sensor measurements 742, 744 shift or change, resulting in sensor measurements 742, 744 that differ or otherwise do not match each other by a measured amount, then one or both of the sensor measurements 742, 744 and the corresponding sensors 652, 640 may be determined as inaccurate. The difference between the sensor measurements 742, 744 may be recorded and compared over time. The sensor measurements 742, 744 and the corresponding sensors 652, 640 may be determined as inaccurate, for example, when the recorded differences suddenly or progressively shift or change over time by at least a predetermined threshold amount.

FIG. 18 is a graph 750 showing sensor measurements 752 generated by sensor 660 indicative of horizontal and/or vertical position (e.g., distance from a reference point) of the clamp 656 of the racker 654 and sensor measurements 754 generated by sensor 668 indicative of horizontal and/or vertical position of the clamp 664 of the guide arm 662 while the racker 654 and the guide arm 662 move each tubular onto or from the fingerboard 166 of the setback 165. The sensor measurements 752, 754 are plotted along the vertical axis, with respect to time, which is plotted along the horizontal axis. The sensor measurements 752, 754 are each shown as a changing profile or curve indicative of a changing horizontal position of the clamps 656, 664 of the racker 654 and the guide arm 662, respectively, while each tubular is moved onto or from the fingerboard 166. The sensor measurements 752, 754 may be compared to each other to validate each other while the racker 654 and the guide arm 662 move in unison to move each tubular.

During wellsite operations, the processing device may continually and/or in real-time compare each of the sensor measurements 752, 754 with the other of the sensor measurements 752, 754 while each tubular is moved between the rack 116 and the well center 603. The processing device may determine accuracy of each sensor measurement 752, 754 based on the comparison with the other of the sensor measurement 752, 754. For example, if the magnitudes and/or profiles of the sensor measurements 752, 754 are substantially similar to or otherwise match each other, as shown in graph 750, then the sensor measurements 752, 754 and the corresponding sensors 660, 668 may be deemed or otherwise determined as accurate, and thus validated. However, if one of the sensor measurements 752, 754 shifts or changes, resulting in sensor measurements 752, 754 that differ or otherwise do not match each other by a measured amount, then one or both of the sensor measurements 752, 754 and the corresponding sensors 660, 668 may be determined as inaccurate. The difference between the sensor measurements 752, 754 may be recorded and compared over time. The sensor measurements 752, 754 and the corresponding sensors 660, 668 may be determined as inaccurate, for example, when the recorded differences suddenly or progressively shift or change over time by at least a predetermined threshold amount.

FIG. 19 is a graph 760 showing sensor measurements 762 generated by sensor 676 indicative of positions (e.g., distances from a reference point) of the skate 133 (shown in FIG. 1) along the catwalk 131 while moving tubulars from the ground level to the drill floor 114. The graph 760 further shows known (i.e., actual) lengths 764 of the tubulars being moved. The sensor measurements 762 and known lengths 764 are plotted along the vertical axis, with respect to time, which is plotted along the horizontal axis. The sensor measurements 762 may be compared to the known lengths 764 (e.g., drill pipe tally plus pin length) of each tubular being moved by the skate 133 when the sensor 611 generates a corresponding sensor signal 765 indicative of a tubular being positioned within the clamp 610 of the delivery arm 602 and, thus, at a known distance 766 from the catwalk 131.

The sensor measurements 762 are shown as a changing profiles or curves indicative of a changing position of the skate 133 while moving the tubulars from the ground level to the drill floor 114 such that the tubulars are positioned within the clamp 610 of the delivery arm 602 one at a time and lifted. The sensor measurements 762 may be indicative of or otherwise utilized to determine the length 768 of each tubular, for example, by determining distance 769 of the skate 133, which abuts the pin end of the tubular, from the edge of the catwalk 131 when the tubular is inserted into the clamp 610 to be picked up, triggering the sensor 611. The distance 766 by which the box end of the tubular extends past the catwalk 131 may be a predetermined value that is substantially constant for each tubular. The length 768 of each tubular may then be determined by taking the sum of the known distance 766 by which the box end of the tubular extends past the catwalk 131 and distance 769 of the skate 133 from the edge of the catwalk 131, indicated by the sensor 676. The distance 766 by which the box end of the tubular extends past the catwalk 131 may also or instead be determined via a sensor 677 in association or otherwise near the catwalk 131. The sensor 677 may be or comprise for example, a proximity sensor, an ultrasound sensor, a light sensor, or a video camera utilizing image recognition software. The length of a tubular may also or instead be determined based on distance between the skate 133 and the edge of the catwalk 131 when the tubular reaches the edge of the catwalk 131. Such distance may by determined by calculating the distance of the skate 133 from the edge of the catwalk 131 based on sensor measurements 762 generated by the sensor 676. The known lengths 764 of the tubulars may be determined by manually measuring such lengths prior to being moved by the catwalk 131 or based on manufacturer drawings and/or other specifications of the tubulars. The known lengths 764, 766 may be fed into the processing system before and/or during the wellsite operations.

During wellsite operations, the processing device may continually determine the distances 768 based on the sensor measurements 762 for each tubular and compare such distances with the known lengths 764 for each tubular moved to the drill floor 114. The processing device may determine accuracy of the sensor measurements 762 based on the comparison with the known lengths 764 with the distances 768. For example, if the distances 768 are substantially similar to or otherwise match the known lengths 764 of the tubulars, as shown in graph 760, then the sensor measurements 762 and the corresponding sensors 676 may be deemed or otherwise determined as accurate, and thus validated. However, if the sensor measurements 762 shift or change, resulting in distances 768 that differ or otherwise do not match the known lengths 764 of the tubulars by a measured amount, then the changed sensor measurements 762 and the corresponding sensor 676 may be determined as inaccurate. The sensor measurements 762 generated by the sensors 676, the distances 768, the known lengths 764, 766 and the differences between the distances 768 and known lengths 764 may be recorded and compared over time. The changed sensor measurements 762 and at least one of the corresponding sensors 676 may be determined as inaccurate, for example, when the recorded differences suddenly or progressively shift or change over time by at least a predetermined threshold amount.

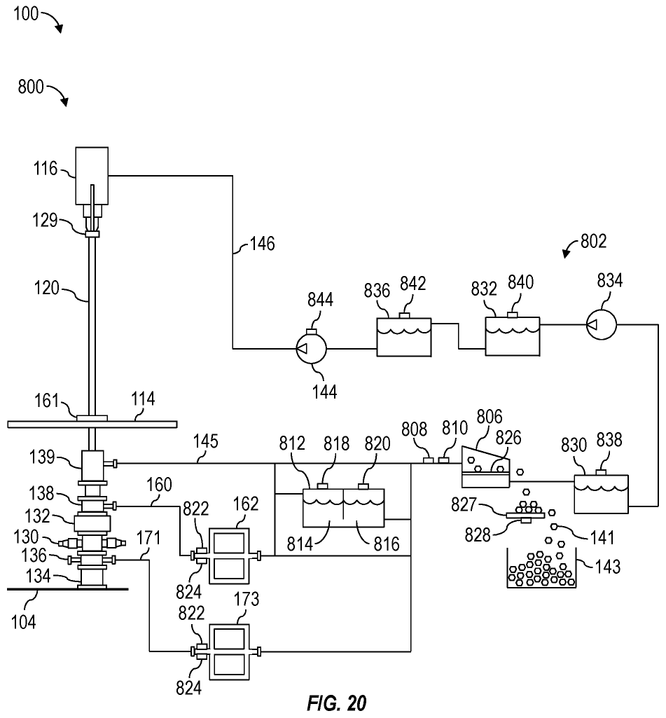

FIG. 20 is a schematic view of an example implementation of a wellsite system 800 comprising a plurality of pipe handling equipment each comprising or carrying one or more sensors operable to generate sensor measurements indicative of corresponding operational parameters and/or states of such equipment. According to one or more aspects of the present disclosure, the wellsite system 800 may be operable to validate or otherwise determine accuracy of selected sensor measurements based on other sensor measurements or known quantities (e.g., actual measurements) at the wellsite. The wellsite system 800 may comprise one or more features of the well construction system 100 shown in FIG. 1 and the control system 200 shown in FIG. 2, including where indicated by the same numerals. The wellsite system 800 may also be operable to perform processes described above in association with FIGS. 3-6. Accordingly, the following description refers to FIGS. 1-6 and 20, collectively.

The wellsite system 800 may comprise BOP equipment, such as a bell nipple 139, an RCD 138, and a ported adapter 136, each of which may be operable to divert drilling fluid returning from the wellbore 102 (shown in FIG. 1) into a corresponding fluid conduit 145, fluid conduit 160, and fluid conduit 171, respectively, each of which may convey the drilling fluid toward and/or into a shale shaker 806. One or more flow sensors 808, 810 may be connected along the fluid conduit 145. Each sensor 808, 810 may be operable to generate sensor data (e.g., signals, measurements) indicative of flow of the drilling fluid being transferred into the shale shaker 806 via the fluid conduit 145. The flow sensors 808, 810 may be or comprise pulse radar flow sensors, each comprising an electromagnetic wave transceivers (not show) operable to direct electromagnetic wave against surface of the drilling fluid flowing through the fluid conduit 145 and to receive corresponding reflected waves indicative of fluid level and, thus, inferred fluid flow. The flow sensors 808, 810 may also or instead be or comprise paddle flow sensors, each comprising a paddle (not shown) configured for contacting the drilling fluid flowing through the fluid conduit 145. The paddle may be rotated, deflected, or otherwise moved based on the volumetric flow rate through the fluid conduit 145. The paddle may be operatively connected with an encoder and/or variable resistor potentiometer (neither shown), such as may be operable to generate sensor data indicative of paddle movements and, thus, fluid flow. The flow rate sensors 808, 810 may also or instead be or comprise Coriolis flowmeters and turbine flowmeters, among other examples.

The fluid conduit 145 and/or the fluid conduit 160 may be fluidly connected with a fluid container 812 (e.g., a trip tank) operable to receive drilling fluid, such as when the drilling fluid is discharged from the wellbore annulus 108 during tripping operations. The fluid container 812 may comprise two or more portions 814, 816 (i.e., volumes) that are fluidly connected with each other. A fluid level sensor 818, 820 may be mounted or otherwise disposed in association with each portion 814, 816 of the fluid container 812 and operable to measure level of the drilling fluid within each corresponding portion 814, 816.

One or more pressure sensors 822, 824 may be fluidly connected at an inlet of or otherwise upstream from one or both of the choke manifolds 162, 173, such as may facilitate measurement of upstream drilling fluid pressure controlled or otherwise caused by each choke manifold 162, 173. The pressure sensors 822, 824 may each be an electrical pressure transducer and/or transmitter operable to generate sensor data (e.g., signals, measurements) indicative of the measured pressure.

The shale shaker 806 may be operable to separate and remove solid particles 141 (e.g., drill cuttings) from the drilling fluid. The shale shaker 806 may comprise a separator tray 826 configured with sieves (not shown) to prevent passage of the solid particles 141 and permit passage of the drilling fluid. The separator tray 826 may be operable to flip or pivot to dump or otherwise expel the solid particles supported by the separator tray 826 into a solids container 143. The shale shaker 806 may comprise a cuttings flow meter operable to generate sensor data (e.g., signals, measurements) indicative of mass flow rate of the solid particles 141 removed from the returning drilling fluid. The cuttings flow meter may be or comprise a weight sensor 828 (e.g., a load cell) disposed in a collector tray 827 in association with the path of the solid particles 141 expelled by the separator tray 826, such as may permit weight of the solid particles 141 expelled by the tray 826 to be measured. The drilling fluid passed through the shale shaker 806 may be further cleaned and/or reconditioned via other drilling fluid reconditioning equipment 170 (shown in FIG. 1) downstream from the shale shaker 806.

The reconditioned drilling fluid may be directed to a fluid container 830 (e.g., transfer tank) for temporary storage. The drilling fluid may be transferred from the fluid container 830 to another fluid container 832 (e.g., an intermediate tank) via a fluid pump 834 (e.g., a centrifugal pump) fluidly connected between the fluid containers 830, 832. The drilling fluid may be transferred from the fluid container 832 to another fluid container 836 (e.g., a suction tank), via a fluid conducting pipe. A corresponding fluid level sensor 838, 840, 842 may be mounted or otherwise disposed in association with each fluid container 830, 832, 836 and operable to measure level of the drilling fluid within each fluid container 830, 832, 836. Each fluid level sensor 818, 820, 838, 840, 842 may be or comprise an electrical fluid level sensor operable to generate sensor data (e.g., signals, measurements) indicative of the amount (e.g., level, volume) of drilling fluid within a corresponding fluid container 830, 832, 836 and container portion 814, 816. The fluid level sensors 818, 820, 838, 840, 842 may comprise contact and/or non-contact sensors, such as conductive, capacitive, vibrating, electromechanical, ultrasonic, microwave, nucleonic, and/or other example sensors. A mud pump 144 (e.g., a triplex piston pump) may then pump the drilling fluid from the container 836 into a top drive 116 via the fluid conduit 146. The drilling fluid may then enter the drill string 120 via an internal fluid passage (not shown) through the top drive 116. The mud pump 144 may instead pump the drilling fluid into and through a fluid swivel (not shown), if a kelly and drilling table are utilized at the wellsite.

A position sensor 844 may be installed or otherwise disposed in association with the pump 144 to monitor or otherwise determine rotational position and/or operating speed (e.g., stroking frequency) of the pump 144. The position sensor 844 may be or comprise a rotary sensor operable to generate sensor data (e.g., electrical signals, measurements) indicative of rotational position and/or operating speed of the pump 144. The rotary sensor may be connected to or disposed adjacent an external portion of a drive shaft of the pump 144 or another rotating member of the pump 144. The rotary sensor may be or comprise an encoder, a synchro, a resolver, and/or a rotary variable differential transformer (RVDT), among other examples. The position sensors may also or instead be or comprise one or more proximity sensors, operable to convert position or presence of selected rotating or otherwise moving portions of the pump 144, such as fluid displacing members, to generate sensor data (e.g., electrical signals, measurements) indicative of rotational position and/or operating speed of the pump 144. One or more of the proximity sensors may also or instead be disposed adjacent a crosshead mechanism or crankshaft of the pump 144 in a manner permitting the detection of the presence and/or movement of a portion of the crosshead mechanism or the crankshaft and, therefore, the rotational position and/or speed of the pump 144 during pumping operations. The proximity sensor may be or comprise a linear encoder, a capacitive sensor, an inductive sensor, a magnetic sensor, a Hall effect sensor, and/or a reed switch, among other examples.

The wellsite system 800 is shown comprising a single quantity of each of the shaker 806, the fluid container 830, the pump 834, the fluid containers 832, 836, and the pump 144 (collectively referred to as a “fluid pumping and reconditioning system 802”) connected in series between fluid conduits 145, 146. However, it is to be understood that the wellsite system 800 may comprise two, three, or more fluid pumping and reconditioning systems 802 fluidly connected in parallel between fluid conduits 145, 146.

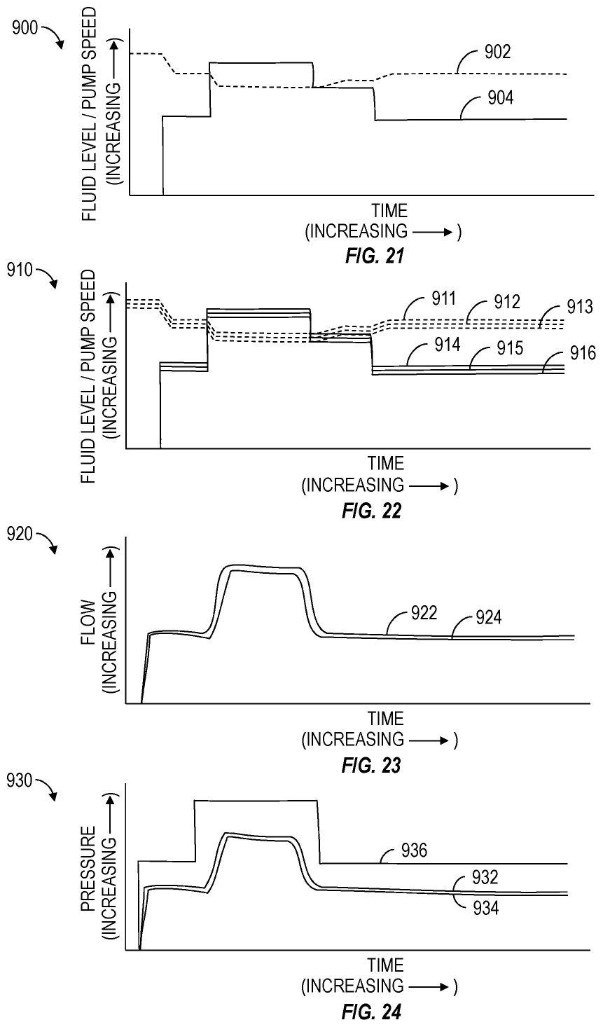

FIG. 21 is a graph 900 showing sensor measurements 902 generated by sensor 842 indicative of drilling fluid level within the fluid container 836 and sensor measurements 904 generated by sensor 844 indicative of rotational or otherwise operational speed (e.g., strokes per minute) of the mud pump 144. The sensor measurements 902, 904 are plotted along the vertical axis, with respect to time, which is plotted along the horizontal axis. The sensor measurements 902 are shown as a changing profile or curve indicative of a changing drilling fluid level within the fluid container 836 while the mud pump 144 changes operational speeds, as indicated by the changing profile or curve of the sensor measurements 904. The sensor measurements 902, 904 may be compared to each other to validate each other while the drilling fluid is being pumped by the mud pump 144.

During wellsite operations (e.g., drilling operations), a processing device, such as the processing device 202, may periodically, continually, and/or in real-time compare the sensor measurements 902, 904 with each other and determine accuracy of the sensor measurements 902, 904 based on the comparison. Because the sensor measurements 902, 904 are indicative of different operational parameters of different pieces of equipment and do not match, the processing device may receive, recognize, and/or establish a predetermined behavioral relationship (e.g., association, correlation) between the operational parameters indicated by the sensor measurements 902, 904. As shown in graph 900, the behavioral relationship between the sensor measurements 902, 904 may be or comprise an inversely proportional relationship, wherein the fluid level in the fluid container 836 decreases when the operational speed of the mud pump 144 increases. Thus, if the profile and/or magnitude of sensor measurements 902, 904 change with respect to each other or otherwise behave pursuant to such predetermined behavioral relationship, as shown in graph 900, then the sensor measurements 902, 904 and the corresponding sensors 842, 844 may be deemed or otherwise determined as being accurate, and thus validated. However, if the sensor measurements 902, 904 suddenly or progressively change resulting in sensor measurements 902, 904 that behave inconsistently with the predetermined behavioral relationship, then at least one of the sensor measurements 902, 904 and the corresponding sensors 842, 844 may be deemed or otherwise determined as being inaccurate, and thus not valid. The sensor measurements 902, 904 may be determined as being inaccurate if, for example, both of the sensor measurements 902, 904 increased or decreased simultaneously. The changed sensor measurements 902, 904 may be determined as being inaccurate, for example, when a difference (e.g., in profile and/or magnitude) between the predetermined behavioral relationship and an unexpected behavioral relationship of the changed sensor measurements 902, 904 is equal to or greater than a predetermined threshold amount.

The sensor measurements 902, 904 may also or instead be converted to actual fluid volumetric flow rates and then compared to each other to validate the accuracy of the sensors 842, 844. For example, the flow rate of the drilling fluid flowing out of the fluid container 836 may be calculated by multiplying the cross sectional dimension of the fluid container 836 by the change rate of the fluid level within the fluid container 836. The flow rate of the drilling fluid flowing out of the pump 144 may be calculated by multiplying the quantity of pressurizing chambers within the pump 144 by the volume of each pressurizing chamber (based on bore or liner size of the pump) and by the rotational rate of the pump 144. The calculated flow rates may then be compared to validate the accuracy of the measurements 902, 904 and the sensors 842, 844.

As described above, the wellsite system 800 may comprise three fluid pumping and reconditioning systems 802, each comprising a corresponding suction tank 836 and mud pump 144. FIG. 22 is a graph 910 showing sensor measurements 911-913 generated by corresponding sensors 842 indicative of drilling fluid levels within the three fluid containers 836, and sensor measurements 914-916 generated by corresponding sensors 844 indicative of rotational or otherwise operational speed of the three mud pumps 144. The sensor measurements 911-913, 914-916 are plotted along the vertical axis, with respect to time, which is plotted along the horizontal axis. The sensor measurements 911-913 are shown as changing profiles or curves indicative of changing drilling fluid levels within the corresponding fluid containers 836 while the mud pumps 144 change operational speed, as indicated by the changing profiles or curve of the sensor measurements 914-916. Each of the sensor measurements 911-913 may be compared with the other of the sensor measurements 911-913 and each of the sensor measurements 914-916 may be compared with the other of the sensor measurements 914-916 to validate the sensor measurements 911-913, 914-916 while the drilling fluid is being pumped by the mud pumps 144.

During wellsite operations when each of the mud pumps 144 is operating at substantially the same speed, the processing device may periodically, continually, and/or in real-time compare each sensor measurement 911-913 with the other of the sensor measurements 911-913 and each sensor measurement 914-916 with the other of the sensor measurements 914-916. The processing device may then determine accuracy of each sensor measurement 911-913, 914-916 based on the comparison. For example, if the fluid level profile indicated by the sensor measurements 911 (validated sensor measurements) is substantially similar to or otherwise matches the fluid level profiles indicated by the other sensor measurements 912, 913 (reference sensor measurements), as shown in graph 910, then the sensor measurements 911 and the corresponding sensor 842 may be deemed or otherwise determined as accurate, and thus validated. Similarly, if the pump speed profile indicated by the sensor measurements 915 (validated sensor measurements) is substantially similar to or otherwise matches the pump speed profiles indicated by the other sensor measurements 914, 916 (reference sensor measurements), as shown in graph 910, then the sensor measurements 915 and the corresponding sensor 844 may be deemed or otherwise determined as accurate, and thus validated. However, if the sensor measurements 911 shift or change, resulting in sensor measurements 911 that differ or otherwise do not match the profiles and/or magnitudes of the sensor measurements 912, 913 by a measured amount, then the changed sensor measurements 911 and the corresponding sensor 842 may be determined as inaccurate. The sensor measurements 911-913, 914-916 generated by the sensors 842, 844, respectively, may be recorded and compared over time. The changed sensor measurements and the corresponding sensor may be determined as inaccurate, for example, when the recorded differences between the validated sensor measurements and the reference sensor measurements suddenly or progressively shift or change over time by at least a predetermined threshold amount.

FIG. 23 is a graph 920 showing sensor measurements 922 generated by sensor 808 indicative of mud flow rate along the fluid conduit 145 and sensor measurements 924 generated by sensor 810 also indicative of mud flow rate along the fluid conduit 145. The sensor measurements 922, 924 are plotted along the vertical axis, with respect to time, which is plotted along the horizontal axis. The sensor measurements 922, 924 are each shown as a changing profile or curve indicative of a changing flow rate of the drilling fluid discharged from the wellbore during successive stages of wellsite operations.

During wellsite operations, the processing device may continually and/or in real-time compare each of the sensor measurements 922, 924 with the other of the sensor measurements 922, 924 to validate the sensor measurements while the drilling fluid is discharged from the wellbore via the fluid conduit 145. The processing device may determine accuracy of each sensor measurement 922, 924 based on the comparison with the other of the sensor measurement 922, 924. For example, if the magnitudes and/or profiles of the sensor measurements 922, 924 are substantially similar to or otherwise match each other, as shown in graph 920, then the sensor measurements 922, 924 and the corresponding sensors 808, 810 may be deemed or otherwise determined as accurate, and thus validated. However, if one of the sensor measurements 922, 924 shifts or changes, resulting in sensor measurements 922, 924 that differ or otherwise do not match each other by a measured amount, then one or both of the sensor measurements 922, 924 and the corresponding sensors 808, 810 may be determined as inaccurate. The difference between the sensor measurements 922, 924 may be recorded and compared over time. The sensor measurements 922, 924 and the corresponding sensors 808, 810 may be determined as inaccurate, for example, when the recorded differences suddenly or progressively shift or change over time by at least a predetermined threshold amount.

FIG. 24 is a graph 930 showing sensor measurements 932 generated by pressure sensor 822 indicative of mud pressure upstream from a selected one of the chokes 162, 173 and sensor measurements 934 generated by sensor 824 also indicative of mud pressure upstream from the selected one of the chokes 162, 173. The sensor measurements 932, 934 are plotted along the vertical axis, with respect to time, which is plotted along the horizontal axis. The sensor measurements 932, 934 are each shown as a changing profile or curve indicative of a changing pressure upstream from a selected one of the chokes 162, 173 while the choke position 936 (i.e., level of restriction) is being adjusted during wellsite operations.

During wellsite operations, the processing device may continually and/or in real-time compare each of the sensor measurements 932, 934 with the other of the sensor measurements 932, 934 to validate the sensor measurements 932, 934 while the drilling fluid is discharged from the wellbore via one of the chokes 162, 173. The processing device may determine accuracy of each sensor measurement 932, 934 based on the comparison with the other of the sensor measurement 932, 934. For example, if the magnitudes and/or profiles of the sensor measurements 932, 934 are substantially similar to or otherwise match each other, as shown in graph 930, then the sensor measurements 932, 934 and the corresponding sensors 822, 824 may be deemed or otherwise determined as accurate, and thus validated. However, if one of the sensor measurements 932, 934 shifts or changes, resulting in sensor measurements 932, 934 that differ or otherwise do not match each other by a measured amount, then one or both of the sensor measurements 932, 934 and the corresponding sensors 822, 824 may be determined as inaccurate. The difference between the sensor measurements 932, 934 may be recorded and compared over time. The sensor measurements 932, 934 and the corresponding sensors 822, 824 may be determined as inaccurate, for example, when the recorded differences suddenly or progressively shift or change over time by at least a predetermined threshold amount.

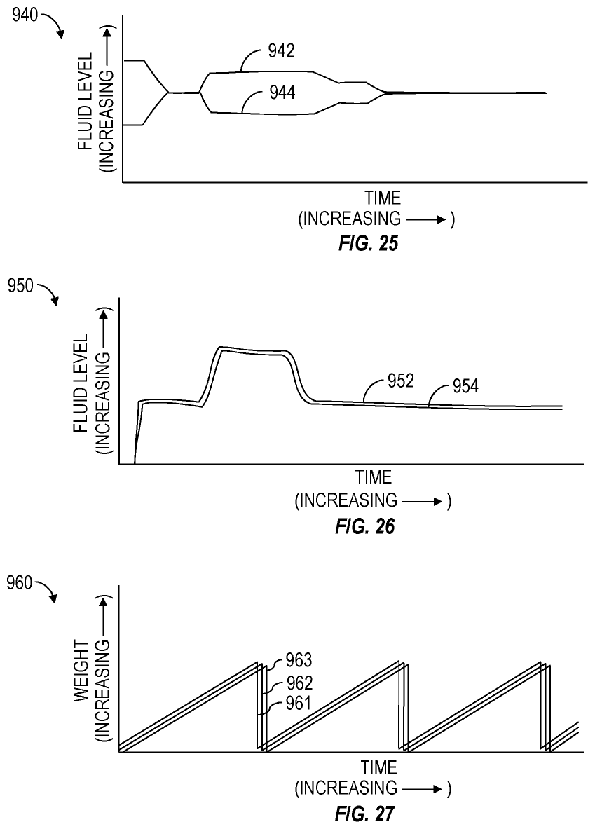

FIG. 25 is a graph 940 showing sensor measurements 942 generated by the fluid level sensor 838 indicative of drilling fluid level within the fluid container 830 and sensor measurements 944 generated by the fluid level sensor 840 indicative of drilling fluid level within the fluid container 832. The sensor measurements 942, 944 are plotted along the vertical axis, with respect to time, which is plotted along the horizontal axis. The sensor measurements 942, 944 are shown as inversely changing profiles or curves indicative of changing drilling fluid level within the corresponding fluid container 830, 832 while the mud pump 834 transfers the drilling fluid from the fluid container 830 to the fluid container 832. The sensor measurements 942, 944 may be compared to each other to validate each other while the drilling fluid is being pumped by the mud pump 834.

During wellsite operations, the processing device may periodically, continually, and/or in real-time compare the sensor measurements 942, 944 with each other and determine accuracy of the sensor measurements 942, 944 based on the comparison. Because the sensor measurements 942, 944 are indicative of operational parameters that behave inversely, the processing device may receive, recognize, and/or establish a predetermined behavioral relationship (e.g., association, correlation) between the operational parameters indicated by the sensor measurements 942, 944. As shown in graph 940, the behavioral relationship between the sensor measurements 942, 944 may be or comprise an inversely proportional relationship, wherein the fluid level in the fluid container 830 decreases while the fluid level in the fluid container 832 increases. Thus, if the profile and/or magnitude of sensor measurements 942, 944 change with respect to each other or otherwise behave pursuant to such predetermined behavioral relationship, as shown in graph 940, then the sensor measurements 942, 944 and the corresponding sensors 838, 840 may be deemed or otherwise determined as being accurate, and thus validated. However, if the sensor measurements 942, 944 suddenly or progressively change resulting in sensor measurements 942, 944 that behave inconsistently with the predetermined behavioral relationship, then at least one of the sensor measurements 942, 944 and the corresponding sensors 838, 840 may be deemed or otherwise determined as being inaccurate, and thus not valid. The sensor measurements 942, 944 may be determined as being inaccurate if, for example, one of the sensor measurements 942, 944 was changing, while the other one of the sensor measurements 942, 944 maintained a constant level. The changed sensor measurements 942, 944 may be determined as being inaccurate, for example, when a difference (e.g., in profile and/or magnitude) between the predetermined behavioral relationship and an unexpected behavioral relationship of the changed sensor measurements 942, 944 is equal to or greater than a predetermined threshold amount.

FIG. 26 is a graph 950 showing sensor measurements 952 generated by sensor 818 indicative of fluid level within the first portion 814 of the fluid container 812 and sensor measurements 954 generated by sensor 820 indicative of fluid level within the second portion 816 of the fluid container 812. The sensor measurements 952, 954 are plotted along the vertical axis, with respect to time, which is plotted along the horizontal axis. The sensor measurements 952, 954 are each shown as a changing profile or curve indicative of a changing level of the drilling fluid discharged from the wellbore during successive tubular tripping operations.

During wellsite operations, the processing device may continually and/or in real-time compare each of the sensor measurements 952, 954 with the other of the sensor measurements 952, 954 to validate the sensor measurements while the drilling fluid is discharged from the wellbore into the fluid container 812. The fluid container portions 814, 816 are fluidly connected and, thus, the fluid level within each portion 814, 816 should equalize to the same level. The processing device may determine accuracy of each sensor measurement 952, 954 based on the comparison with the other of the sensor measurement 952, 954. For example, if the magnitudes and/or profiles of the sensor measurements 952, 954 are substantially similar to or otherwise match each other, as shown in graph 920, then the sensor measurements 952, 954 and the corresponding sensors 818, 820 may be deemed or otherwise determined as accurate, and thus validated. However, if one of the sensor measurements 952, 954 shifts or changes, resulting in sensor measurements 952, 954 that differ or otherwise do not match each other by a measured amount, then one or both of the sensor measurements 952, 954 and the corresponding sensors 818, 820 may be determined as inaccurate. The difference between the sensor measurements 952, 954 may be recorded and compared over time. The sensor measurements 952, 954 and the corresponding sensors 818, 820 may be determined as inaccurate, for example, when the recorded differences suddenly or progressively shift or change over time by at least a predetermined threshold amount.

As described above, the wellsite system 800 may comprise three fluid pumping and reconditioning systems 802, each comprising a corresponding shale shaker 806. FIG. 27 is a graph 960 showing sensor measurements 961-963, each generated by a corresponding load (i.e., weight) sensor 828 of a shale shaker 806. Each sensor measurement 961-963 may be indicative of weight of drill cuttings 141 supported by a separator tray 826 of a corresponding shale shaker 806 while the drill cuttings are expelled onto the collector tray 827. The collector tray 827 may be periodically flipped over to remove the accumulated drill cuttings 141 and, thus, reduce the weight of the drill cuttings supported by the collector r tray 827. Each sensor measurement 961-963 may be indicative of the cuttings mass flow rate passed by a corresponding shale shaker 806. The sensor measurements 961-963 are plotted along the vertical axis, with respect to time, which is plotted along the horizontal axis. The sensor measurements 961-963 are shown as changing profiles or curves, each indicative of a changing weight of the drill cuttings supported by the separator tray 826 while the drill cuttings 141 are received by and periodically removed from the separator tray 826. Each of the sensor measurements 961-963 may be compared to the other of the sensor measurements 961-963 to validate the sensor measurements 961-963 while the drill cuttings 141 are being separated from the drilling fluid discharged from the wellbore.

During wellsite operations when each of the shale shakers 806 is operating in sync and at substantially the same speed, the processing device may periodically, continually, and/or in real-time compare each sensor measurement 961-963 with the other of the sensor measurements 961-963. The processing device may then determine accuracy of each sensor measurement 961-963 based on the comparison. For example, if the weight profile indicated by the sensor measurements 961 (validated sensor measurements) is substantially similar to or otherwise matches the weight profiles indicated by the other sensor measurements 962, 963 (reference sensor measurements), as shown in graph 960, then the sensor measurements 961 and the corresponding sensor 828 may be deemed or otherwise determined as accurate, and thus validated. However, if the sensor measurements 961 shift or change, resulting in sensor measurements 961 that differ or otherwise do not match the profiles and/or magnitudes of the sensor measurements 962, 963 by a measured amount, then the changed sensor measurements 961 and the corresponding sensor 828 may be determined as inaccurate. The sensor measurements 961-963 generated by the sensors 828 and the differences between the sensor measurements 961-963 may be recorded and compared over time. The changed sensor measurements 961 and the corresponding sensor 828 may be determined as inaccurate, for example, when the recorded differences between the sensor measurements 961 and the sensor measurements 962, 963 suddenly or progressively shift or change over time by at least a predetermined threshold amount.

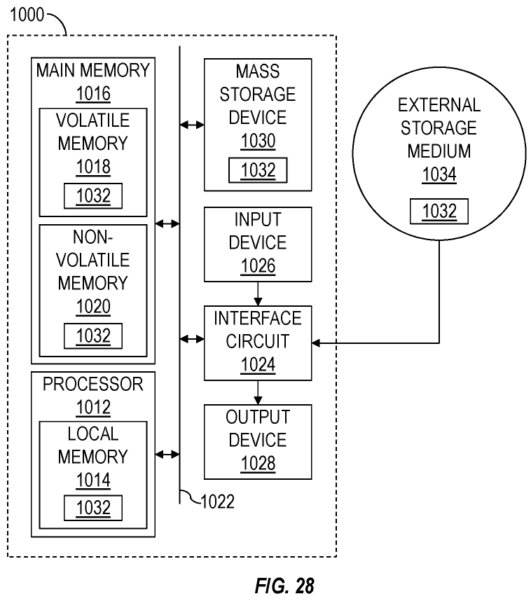

FIG. 28 is a schematic view of at least a portion of an example implementation of a processing system 1000 (or device) according to one or more aspects of the present disclosure. The processing system 1000 may be or form at least a portion of one or more equipment controllers and/or other electronic devices shown in one or more of the FIGS. 1-27. Accordingly, the following description refers to FIGS. 1-28, collectively.

The processing system 1000 may be or comprise, for example, one or more processors, controllers, special-purpose computing devices, PCs (e.g., desktop, laptop, and/or tablet computers), personal digital assistants, smartphones, IPCs, PLCs, servers, internet appliances, and/or other types of computing devices. The processing system 1000 may be or form at least a portion of the processing device 192, 202. The processing system 1000 may be or form at least a portion of the local controllers 221-226. Although it is possible that the entirety of the processing system 1000 is implemented within one device, it is also contemplated that one or more components or functions of the processing system 1000 may be implemented across multiple devices, some or an entirety of which may be at the wellsite and/or remote from the wellsite.

The processing system 1000 may comprise a processor 1012, such as a general-purpose programmable processor. The processor 1012 may comprise a local memory 1014, and may execute machine-readable and executable program code instructions 1032 (i.e., computer program code) present in the local memory 1014 and/or another memory device. The processor 1012 may execute, among other things, the program code instructions 1032 and/or other instructions and/or programs to implement the example methods and/or operations described herein. For example, the program code instructions 1032, when executed by the processor 1012 of the processing system 1000, may cause the processor 1012 to receive and process (e.g., compare) sensor data (e.g., sensor measurements) and output information indicative of accuracy the sensor data and, thus, the corresponding sensors according to one or more aspects of the present disclosure. The program code instructions 1032, when executed by the processor 1012 of the processing system 1000, may also or instead cause one or more portions or pieces of wellsite equipment of a well construction system to perform the example methods and/or operations described herein. The processor 1012 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Examples of the processor 1012 include one or more INTEL microprocessors, microcontrollers from the ARM and/or PICO families of microcontrollers, embedded soft/hard processors in one or more FPGAs.

The processor 1012 may be in communication with a main memory 1016, such as may include a volatile memory 1018 and a non-volatile memory 1020, perhaps via a bus 1022 and/or other communication means. The volatile memory 1018 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 1020 may be, comprise, or be implemented by read-only memory, flash memory, and/or other types of memory devices. One or more memory controllers (not shown) may control access to the volatile memory 1018 and/or non-volatile memory 1020.

The processing system 1000 may also comprise an interface circuit 1024, which is in communication with the processor 1012, such as via the bus 1022. The interface circuit 1024 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 1024 may comprise a graphics driver card. The interface circuit 1024 may comprise a communication device, such as a modem or network interface card to facilitate exchange of data with external computing devices via a network (e.g., Ethernet connection, digital subscriber line (DSL), telephone line, coaxial cable, cellular telephone system, satellite, etc.).

The processing system 1000 may be in communication with various sensors, video cameras, actuators, processing devices, equipment controllers, and other devices of the well construction system via the interface circuit 1024. The interface circuit 1024 can facilitate communications between the processing system 1000 and one or more devices by utilizing one or more communication protocols, such as an Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol.

One or more input devices 1026 may also be connected to the interface circuit 1024. The input devices 1026 may permit human wellsite operators 195 to enter the program code instructions 1032, which may be or comprise control commands, operational parameters, and/or operational set-points. The program code instructions 732 may further comprise modeling or predictive routines, equations, algorithms, processes, applications, and/or other programs operable to perform example methods and/or operations described herein. The input devices 1026 may be, comprise, or be implemented by a keyboard, a mouse, a joystick, a touchscreen, a track-pad, a trackball, an isopoint, and/or a voice recognition system, among other examples. One or more output devices 1028 may also be connected to the interface circuit 1024. The output devices 1028 may permit for visualization or other sensory perception of various data, such as sensor data, status data, and/or other example data. The output devices 1028 may be, comprise, or be implemented by video output devices (e.g., an LCD, an LED display, a CRT display, a touchscreen, etc.), printers, and/or speakers, among other examples. The one or more input devices 1026 and the one or more output devices 1028 connected to the interface circuit 1024 may, at least in part, facilitate the HMIs described herein.

The processing system 1000 may comprise a mass storage device 1030 for storing data and program code instructions 1032. The mass storage device 1030 may be connected to the processor 1012, such as via the bus 1022. The mass storage device 1030 may be or comprise a tangible, non-transitory storage medium, such as a floppy disk drive, a hard disk drive, a compact disk (CD) drive, and/or digital versatile disk (DVD) drive, among other examples. The processing system 1000 may be communicatively connected with an external storage medium 1034 via the interface circuit 1024. The external storage medium 1034 may be or comprise a removable storage medium (e.g., a CD or DVD), such as may be operable to store data and program code instructions 1032.

As described above, the program code instructions 1032 may be stored in the mass storage device 1030, the main memory 1016, the local memory 1014, and/or the removable storage medium 1034. Thus, the processing system 1000 may be implemented in accordance with hardware (perhaps implemented in one or more chips including an integrated circuit, such as an ASIC), or may be implemented as software or firmware for execution by the processor 1012. In the case of firmware or software, the implementation may be provided as a computer program product including a non-transitory, computer-readable medium or storage structure embodying computer program code instructions 1032 (i.e., software or firmware) thereon for execution by the processor 1012. The program code instructions 732 may include program instructions or computer program code that, when executed by the processor 712, may perform and/or cause performance of example methods, processes, and/or operations described herein.

In view of the entirety of the present disclosure, including the figures and the claims, a person having ordinary skill in the art will readily recognize that the present disclosure introduces a method comprising commencing operation of a processing device, whereby the processing device: receives a sensor measurement output from a sensor at an oil and gas wellsite while a wellsite operation is being performed; compares the sensor measurement to a known quantity; and determines accuracy of the sensor measurement based on the comparison.

The sensor measurement may be indicative of an operational parameter of an action performed by a corresponding piece of equipment at the wellsite as part of the wellsite operation.

The known quantity may be indicative of at least one of a known position, a known distance, a known weight, and a known length.

Comparing the sensor measurement to the known quantity may comprise determining a difference between the sensor measurement and the known quantity.

Comparing the sensor measurement to the known quantity may be performed at a predetermined stage of the wellsite operation when the sensor measurement is intended to be equal to the known quantity.

Determining the accuracy of the sensor measurement may comprise determining that the sensor measurement is accurate when the sensor measurement is substantially equal to the known quantity.

Determining the accuracy of the sensor measurement may comprise determining that the sensor measurement is inaccurate when the sensor measurement and the known quantity differ by a predetermined amount.

Determining the accuracy of the sensor measurement may comprise determining that the sensor measurement is inaccurate when a difference between the sensor measurement and the known quantity is equal to or greater than a predetermined threshold quantity associated with the sensor.

The sensor may be disposed in association with a piece of equipment at the wellsite, and the sensor may output the sensor measurement while the piece of equipment is performing an action as part of the wellsite operation.

In an example implementation, among others within the scope of the present disclosure, the sensor may be a first sensor disposed in association with a drawworks operated as part of the wellsite operation, the sensor measurement may be indicative of position of a traveling block that moves vertically along a mast via operation of the drawworks, the known quantity may be indicative of a known position of a second sensor disposed along the mast, and comparing the sensor measurement to the known quantity may be performed when the traveling block passes the second sensor while moving vertically along the mast thereby causing the second sensor to output a signal.

In an example implementation, among others within the scope of the present disclosure, the sensor may be disposed in association with a delivery arm for picking up and moving a tubular as part of the wellsite operation, the sensor measurement may be indicative of weight supported by the delivery arm, the known quantity may be a known weight of the tubular, and comparing the sensor measurement to the known quantity may be performed while the delivery arm picks up the tubular.

In an example implementation, among others within the scope of the present disclosure, the sensor may be a first sensor disposed in association with a drawworks for vertically moving a delivery arm for picking up and moving a tubular as part of the wellsite operation, the sensor measurement may be indicative of vertical position of the delivery arm during vertical movement of the delivery arm along a mast, the known quantity may be a known vertical position of a second sensor disposed along the mast, and comparing the sensor measurement to the known quantity may be performed while the delivery arm moves vertically along the mast past the second sensor, thereby causing the second sensor to output a signal.

In an example implementation, among others within the scope of the present disclosure, the sensor may be disposed in association with a stabilization arm for stabilizing an upright tubular as part of the wellsite operation, the sensor measurement may be indicative of horizontal position of the stabilization arm, the known quantity may be a known horizontal position, and comparing the sensor measurement to the known quantity may be performed while the upright tubular is: stabilized by the stabilizing arm; and being threadedly coupled to another tubular extending from a wellbore. The known horizontal position may be center of the wellbore.

In an example implementation, among others within the scope of the present disclosure, the sensor may be disposed in association with a positioner operable to horizontally move a tubular to a predetermined location as part of the wellsite operation, the sensor measurement may be indicative of a horizontal position of the positioner, the known quantity may be a known horizontal position of the predetermined location, and comparing the sensor measurement to the known quantity may be performed while the tubular is being threadedly coupled to another tubular at the predetermined location. The predetermined location may be a wellbore center or a mouse hole center.

In an example implementation, among others within the scope of the present disclosure, the sensor may be a first sensor disposed in association with a catwalk, the sensor measurement may be indicative of position of a skate of the catwalk, the known quantity may be a known length of a tubular being moved by the skate along the catwalk as part of the wellsite operation, and comparing the sensor measurement to the known quantity may be performed when the tubular being moved by the skate causes a second sensor to output a signal thereby causing the skate to stop. Distance between the skate and the second sensor may be equal to the known length of the tubular when the skate stops.

The present disclosure also introduces a method comprising commencing operation of a processing device, whereby the processing device: (A) compares a first measurement to a second measurement, wherein: (i) the first measurement is output by a first sensor at an oil and gas wellsite while a wellsite operation is performed; and (ii) the second measurement is output by a second sensor at the wellsite while the wellsite operation is performed; and (B) determines accuracy of at least one of the first and second measurements based on the comparison of the first and second measurements.

Comparing the first and second measurements may comprise determining a difference between the first and second measurements.

Comparing the first and second measurements may be performed at a predetermined stage of the wellsite operation when the first and second measurements are intended to be equal.

Determining the accuracy of at least one of the first and second measurements may comprise determining that the first and second measurements are accurate when the first and second measurements are substantially equal to each other.

Determining the accuracy of at least one of the first and second measurements may comprise determining that at least one of the first and second measurements is inaccurate when the first and second measurements differ by at least a predetermined amount.

Determining the accuracy of at least one of the first and second measurements may comprise determining that at least one of the first and second measurements is inaccurate when a difference between the first and second measurements is equal to or greater than a predetermined threshold quantity.

Determining the accuracy of at least one of the first and second measurements may comprise determining that at least one of the first and second measurements is inaccurate when the first and second measurements change unpredictably with respect to each other during the wellsite operation.

In an example implementation, among others within the scope of the present disclosure, the first measurement may be indicative of a first operational parameter of a first action performed at the wellsite, the second measurement may be indicative of a second operational parameter of a second action performed at the wellsite, and the first and second actions may be part of the wellsite operation.

In an example implementation, among others within the scope of the present disclosure, the first sensor may be disposed in association with a first piece of equipment at the wellsite, the second sensor may be disposed in association with a second piece of equipment at the wellsite, the first measurement may be output by the first sensor while the first piece of equipment is performing a first action as part of the wellsite operation, and the second measurement may be output by the second sensor while the second piece of equipment is performing a second action as part of the wellsite operation. The first and second pieces of equipment may be distinct pieces of equipment that are operatively connected. The first and second measurements may be simultaneously output by the respective first and second sensors while the first and second pieces of equipment simultaneously perform the respective first and second actions.

In an example implementation, among others within the scope of the present disclosure, the first sensor may be disposed in association with a piece of equipment at the wellsite, the second sensor may be disposed in association the piece of equipment, and the first and second sensors may output the respective first and second measurements while the piece of equipment is performing at least a portion of the wellsite operation.

In an example implementation, among others within the scope of the present disclosure, the first sensor may be disposed in association with a first member supporting a top drive operated as part of the wellsite operation, the second sensor may be disposed in association with a second member supporting the top drive, the first measurement may be indicative of tension experienced by the first member, and the second measurement may be indicative of tension experienced by the second member.

In an example implementation, among others within the scope of the present disclosure, the first sensor may be disposed in association with a member supporting a top drive operated as part of the wellsite operation, the second sensor may be disposed in association with a deadline anchor at the wellsite, the first measurement may be indicative of tension experienced by the member, and the second measurement may be indicative of tension experienced by a cable secured by the deadline anchor.

In an example implementation, among others within the scope of the present disclosure, the first sensor may be disposed in association with a first positioner, the second sensor may be disposed in association with a second positioner, the first and second positioners may be operable to cooperatively move a tubular horizontally to a predetermined location as part of the wellsite operation, the first measurement may be indicative of horizontal position of the first positioner, and the second measurement may be indicative of horizontal position of the second positioner. The first and second sensors may output the respective first and second measurements while the tubular is being threadedly coupled to another tubular extending from a wellbore or a mouse hole.

In an example implementation, among others within the scope of the present disclosure, the first sensor may be disposed in association with a first arm, the second sensor may be disposed in association with a second arm, the first and second arms may be operable to cooperatively hold and move a tubular vertically between predetermined locations as part of the wellsite operation, the first measurement may be indicative of position of the first arm, and the second measurement may be indicative of position of the second arm.

In an example implementation, among others within the scope of the present disclosure, the first sensor may be disposed in association with a fluid container at the wellsite, the second sensor may be disposed in association with a fluid pump at the wellsite, the first measurement may be indicative of fluid level within the fluid container, and the second measurement may be indicative of operational speed of the fluid pump. The first and second sensors may output the respective first and second measurements while the fluid pump is pumping fluid out of the fluid container as part of the wellsite operation.

In an example implementation, among others within the scope of the present disclosure, the first sensor may be disposed in association with a first fluid container at the wellsite, the second sensor may be disposed in association with a second fluid container at the wellsite, the first measurement may be indicative of fluid level within the first fluid container during the wellsite operation, and the second measurement may be indicative of fluid level within the second fluid container during the wellsite operation. The first and second sensors may output the respective first and second measurements while fluid is transferred between the first and second fluid containers as part of the wellsite operation.

The first and second sensors may each be disposed in association with a fluid conduit at the wellsite, and the first and second measurements may each be indicative of fluid flow rate through the fluid conduit during the wellsite operation.

In an example implementation, among others within the scope of the present disclosure, the first sensor may be disposed in association with a first fluid conduit at the wellsite, the second sensor may be disposed in association with a second fluid conduit at the wellsite, the first measurement may be indicative of fluid flow rate through the first fluid conduit during the wellsite operation, and the second measurement may be indicative of fluid flow rate through the second fluid conduit during the wellsite operation.

In an example implementation, among others within the scope of the present disclosure, the first sensor may be disposed in association with a piece of equipment at the wellsite, the second sensor may be disposed in association the piece of equipment, and the first and second measurements may each be indicative of fluid pressure facilitated by the common piece of equipment during the wellsite operation. The piece of equipment may be or comprise a choke manifold.

In an example implementation, among others within the scope of the present disclosure, the first sensor may be disposed in association with a first shale shaker, the second sensor may be disposed in association with a second shale shaker, the first measurement may be indicative of weight of drill cuttings passing through the first shale shaker during the wellsite operation, and the second measurement may be indicative of weight of drill cuttings passing through the second shale shaker during the wellsite operation.

The present disclosure also introduces a system comprising: (A) a sensor disposed in association with a piece of equipment at an oil and gas wellsite, wherein the sensor is operable to output a first measurement while a wellsite operation is performed; and (B) a processing device comprising a processor and a memory storing computer program code, wherein the processing device is operable to: (i) compare the first measurement to a second measurement; and (ii) determine accuracy of at least one of the first and second measurements based on the comparison.

Comparing the first and second measurements may comprise determining a difference between the first and second measurements.

Comparing the first and second measurements may be performed at a predetermined stage of the wellsite operation when the first and second measurements are intended to be substantially equal.

Determining the accuracy of at least one of the first and second measurements may comprise determining that the first and second measurements are accurate when the first and second measurements are substantially equal to each other.

Determining the accuracy of at least one of the first and second measurements may comprise determining that at least one of the first and second measurements is inaccurate when the first and second measurements are appreciably different.

Determining the accuracy of at least one of the first and second measurements may comprise determining that at least one of the first and second measurements is inaccurate when a difference between the first and second measurements is equal to or greater than a predetermined threshold quantity.

Determining the accuracy of at least one of the first and second measurements may comprise determining that at least one of the first and second measurements is inaccurate when the first and second measurements change unpredictably with respect to each other.

In an example implementation, among others within the scope of the present disclosure, the first measurement may be indicative of an operational parameter of an action performed by the piece of equipment as part of the wellsite operation, and the second measurement may be a known quantity. The known quantity may be indicative of at least one of a known position, a known distance, a known weight, and a known length.

In an example implementation, among others within the scope of the present disclosure, the sensor may be a first sensor, the system may comprise a second sensor operable to output the second measurement while the wellsite operation is performed, the first measurement may be indicative of a first operational parameter of a first action performed as part of the wellsite operation, and the second measurement may be indicative of a second operational parameter of a second action performed as part of the wellsite operation.

In an example implementation, among others within the scope of the present disclosure, the sensor may be a first sensor, the piece of equipment may be a first piece of equipment, the system may comprise a second sensor disposed in association with a second piece of equipment utilized at the oil and gas wellsite during the wellsite operation, and the second sensor may be operable to output the second measurement while the wellsite operation is performed. The first and second pieces of equipment may be distinct pieces of equipment, and the first and second pieces of equipment may be operatively connected.

In an example implementation, among others within the scope of the present disclosure, the sensor may be a first sensor, the system may comprise a second sensor disposed in association with the piece of equipment, and the second sensor may be operable to output the second measurement while the wellsite operation is performed.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. A method comprising:
commencing operation of a processing device, whereby the processing device:
receives a sensor measurement output from a sensor at an oil and gas wellsite while a wellsite operation is being performed;
compares the sensor measurement to a known quantity; and
determines accuracy of the sensor measurement based on the comparison.

2. The method of claim 1 wherein the sensor measurement is indicative of an operational parameter of an action performed by a corresponding piece of equipment at the wellsite as part of the wellsite operation.

3. The method of claim 1 wherein the known quantity is indicative of at least one of a known position, a known distance, a known weight, and a known length.

4. The method of claim 1 wherein comparing the sensor measurement to the known quantity is performed at a predetermined stage of the wellsite operation when the sensor measurement is intended to be equal to the known quantity.

5. The method of claim 1 wherein determining the accuracy of the sensor measurement comprises determining that the sensor measurement is accurate when the sensor measurement is substantially equal to the known quantity.

6. The method of claim 1 wherein determining the accuracy of the sensor measurement comprises determining that the sensor measurement is inaccurate when the sensor measurement and the known quantity differ by a predetermined amount.

7. The method of claim 1 wherein the sensor is disposed in association with a piece of equipment at the wellsite, and wherein the sensor outputs the sensor measurement while the piece of equipment is performing an action as part of the wellsite operation.

8. A method comprising:
commencing operation of a processing device, whereby the processing device:
compares a first measurement to a second measurement, wherein:
the first measurement is output by a first sensor at an oil and gas wellsite while a wellsite operation is performed; and
the second measurement is output by a second sensor at the wellsite while the wellsite operation is performed; and
determines accuracy of at least one of the first and second measurements based on the comparison of the first and second measurements.

9. The method of claim 8 wherein comparing the first and second measurements is performed at a predetermined stage of the wellsite operation when the first and second measurements are intended to be equal.

10. The method of claim 8 wherein determining the accuracy of at least one of the first and second measurements comprises determining that the first and second measurements are accurate when the first and second measurements are substantially equal to each other.

11. The method of claim 8 wherein determining the accuracy of at least one of the first and second measurements comprises determining that at least one of the first and second measurements is inaccurate when a difference between the first and second measurements is equal to or greater than a predetermined threshold quantity.

12. The method of claim 8 wherein:
the first measurement is indicative of a first operational parameter of a first action performed at the wellsite;
the second measurement is indicative of a second operational parameter of a second action performed at the wellsite; and
the first and second actions are part of the wellsite operation.

13. The method of claim 8 wherein:
the first sensor is disposed in association with a first piece of equipment at the wellsite;
the second sensor is disposed in association with a second piece of equipment at the wellsite;
the first measurement is output by the first sensor while the first piece of equipment is performing a first action as part of the wellsite operation; and
the second measurement is output by the second sensor while the second piece of equipment is performing a second action as part of the wellsite operation.

14. The method of claim 8 wherein:
the first sensor is disposed in association with a piece of equipment at the wellsite;
the second sensor is disposed in association the piece of equipment; and
the first and second sensors output the respective first and second measurements while the piece of equipment is performing at least a portion of the wellsite operation.

15. A system comprising:
a sensor disposed in association with a piece of equipment at an oil and gas wellsite, wherein the sensor is operable to output a first measurement while a wellsite operation is performed; and
a processing device comprising a processor and a memory storing computer program code, wherein the processing device is operable to:
compare the first measurement to a second measurement; and
determine accuracy of at least one of the first and second measurements based on the comparison.

16. The system of claim 15 wherein comparing the first and second measurements is performed at a predetermined stage of the wellsite operation when the first and second measurements are intended to be substantially equal.

17. The system of claim 15 wherein determining the accuracy of at least one of the first and second measurements comprises determining that the first and second measurements are accurate when the first and second measurements are substantially equal to each other.

18. The system of claim 15 wherein determining the accuracy of at least one of the first and second measurements comprises determining that at least one of the first and second measurements is inaccurate when a difference between the first and second measurements is equal to or greater than a predetermined threshold quantity.

19. The system of claim 15 wherein the first measurement is indicative of an operational parameter of an action performed by the piece of equipment as part of the wellsite operation, and wherein the second measurement is a known quantity.

20. The system of claim 15 wherein:
the sensor is a first sensor;
the system further comprises a second sensor operable to output the second measurement while the wellsite operation is performed;
the first measurement is indicative of a first operational parameter of a first action performed as part of the wellsite operation; and
the second measurement is indicative of a second operational parameter of a second action performed as part of the wellsite operation.
